(19) United States
(12) Patent Application Publication
(10) Pub. No.: US 2018/0175638 A1
(43) Pub. Date: Jun. 21, 2018

(54) METHOD AND SYSTEM FOR SMART BATTERY AND APPLICATION THEREOF

(71) Applicant: Jiping Zhu, Flushing, NY (US)

(72) Inventor: Jiping Zhu, Flushing, NY (US)

(21) Appl. No.: 15/380,805

(22) Filed: Dec. 15, 2016

(51) Int. Cl. H02J 7/00

(52) U.S. Cl. CPC H02J 7/0021; H02J 2007/0098

(57) ABSTRACT

The present teaching relates to a battery module, which comprises a plurality of battery cells, a peripheral circuit coupled with the plurality of battery cells, and a module service management controller coupled with the plurality of battery cells and the peripheral circuit and configured for initiating a module service request when battery service is needed. The disclosed battery module is associated with a battery module identifier (BMID) that uniquely identifies the battery module.

### BACKGROUND

### 1. Technical Field

The present teaching generally relates to battery. More specifically, the present teaching relates to intelligent battery and applications thereof.

### 2. Technical Background

With the advancement of electronics, the usage of batteries is ubiquitous. More and more batteries are made nowadays re-chargeable. That is, if the electricity level of a battery is down, it can be re-charged to its full capacity and continues to be used again in whatever application scenario it is deployed. This ranges from small electronic devices to equipment and moving vehicles. In some application scenarios, especially electronics, it is a matter of replacing the battery with a charged battery so that the replaced battery can be re-charged for the next round of use. In some applications, equipment operating on a battery that needs re-charge can be plugged in a socket whenever there is one. Examples include a smart phone or an electric vehicle can be plugged in a socket to be connected with power supply for the re-charge. The length of charging time varies, depending on the application or the level of power needed to operate the application. Generally, re-charging takes often several hours, as in the case for, e.g., a smart phone or an electric vehicle.

The disadvantage of the required time for re-charging a battery can be appreciated in daily lives. Out in the fields with a device, instrument, or device that runs out of power can be disrupting in whatever is intended. A fully charged battery used in an electric car usually lasts for only 3-4 hours, according to the state of the art, making it difficult to use electric cars for anything else except short distance drive. This is not which prevents electric cars from being used more extensively. As such, the advantage of electric cars not only cannot be extended to long distance driving situations but also cannot be fully exploited for the benefit of environment.

In addition to the need for re-charging a battery, there is also the issue when a battery is detected to mal-function and needs to be replaced. The problem associated with a battery is often not detected until it negatively affects the performance of the application (e.g., electric cars, hand held devices, equipment in the field, etc.) is so degraded. At that point, the operation of the application has to be ceased before a replacement battery arrives.

Additional disadvantages of the current battery technology exist, especially with respect to batteries deployed in moving vehicles. In general, a conventional battery pack is attached to a moving vehicle in such a manner that is not easy to de-attach and usually requires manual labor to do so. As such, replacing a battery in a moving vehicle is slow and expensive. In addition, as shown in FIG. 1A, a conventional battery pack 110 is usually treated as a single unit, having one peripheral circuit 120 for the entire battery pack 130, as illustrated. The readings from the peripheral circuit 120 are provided to vehicle electronics 140 in the moving vehicle which may subsequently be used by, e.g., the vehicle communication center 150 so that battery status may be displayed to the user of the moving vehicle. Although the battery pack 130 is organized to include multiple modules 160, each of which includes multiple cells 170, as shown in FIG. 1B, when a particular module in the pack has problems, the entire pack usually has to be replaced. No individual monitoring is applied to modules. Although it is not impossible to detect and replace a specific defective module, it requires manual diagnosis and manual disassembly of the pack, which is time consuming and, hence, expensive.

Thus, there is a need for an improved battery solution. The present teaching aims to provide such an improved battery solution.

### SUMMARY

The teachings disclosed herein relate to methods, systems, and programming for advertising. More particularly, the present teaching relates to methods, systems, and programming related to exploring sources of advertisement and utilization thereof.

In some embodiments, the present teaching discloses a battery module, which comprises a plurality of battery cells, a peripheral circuit coupled with the plurality of battery cells, and a module service management controller coupled with the plurality of battery cells and the peripheral circuit and configured for initiating a module service request when battery service is needed. The disclosed battery module is associated with a battery module identifier (BMID) that uniquely identifies the battery module.

In some different embodiments, the present teaching discloses a battery pack, which comprises a plurality of battery modules, each which includes more than one battery cells and an associated module service management controller and a pack service management controller. The pack service management controller is coupled with the plurality of battery modules and is configured to determine whether a battery service is needed based on information received from the plurality of battery modules. When it is determined that a battery service is needed, the pack service management controller sends a service request to a battery service provider with information related to the battery pack and/or the plurality of battery modules.

In yet other different embodiment, the present teaching discloses a system for providing battery services. The disclosed system comprises a service request processor configured for processing a service request initiated by a battery for a battery service, wherein the battery is associated with a first unique identifier. The disclosed system also comprises a service scheduler configured for scheduling the requested battery service based on information related to the battery including a current state of the battery and a service configuration unit configured for automatically configuring resources needed for the requested battery service, including a robot to deliver the requested battery service and/or a replacement battery to be used to replace the battery which is associated with a second unique identifier and has a deployment state. The system also includes a service delivery center configured for delivering the requested battery service using the configured resources and a post service handling unit configured for determining a service charge based on the current state of the battery and the deployment state of the replacement battery.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A (PRIOR ART) illustrates a typical battery system and/or its connection with a mechanism in a moving vehicle;

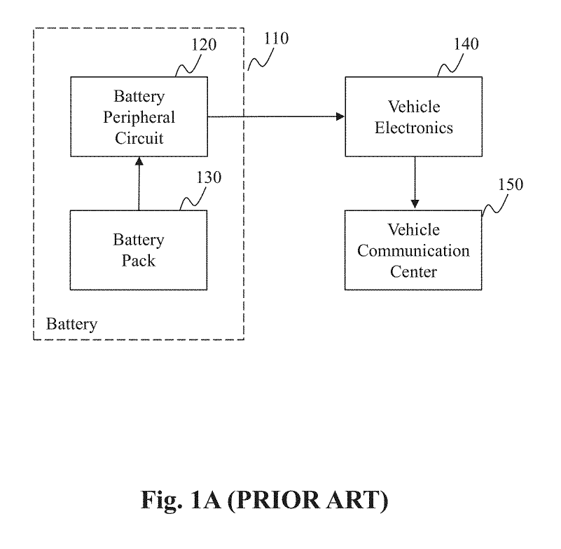

FIG. 1B depicts a typical battery pack construct;

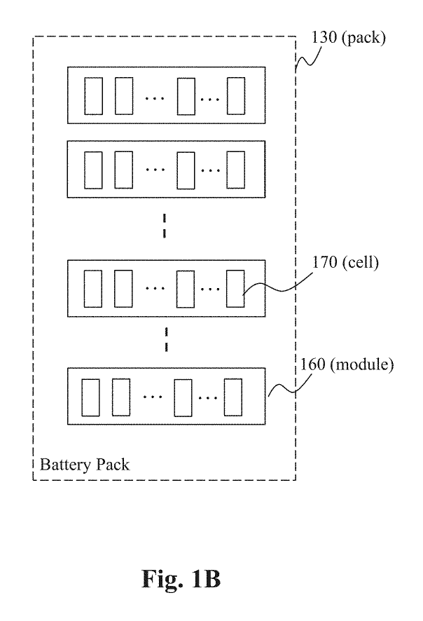

FIG. 2A depicts an exemplary improved battery system that is capable of modular construct in which each battery module is monitored for needed services individually with the ability of self-initiating needed battery module service, according to an embodiment of the present teaching;

FIG. 2B provides an exemplary battery pack configuration, according to an embodiment of the present invention;

FIG. 2C depicts an exemplary battery module diagram, according to an embodiment of the present invention;

FIG. 3A depicts an exemplary system diagram of a module service management controller in a battery module, according to an embodiment of the present teaching;

FIG. 3B illustrates exemplary types of information in a battery application configuration for moving vehicles, according to an embodiment of the present teaching;

FIG. 3C illustrates exemplary types of information in a battery usage configuration, according to an embodiment of the present teaching;

FIG. 4 is a flowchart of an exemplary process for a module service management controller in a battery module, according to an embodiment of the present teaching;

FIG. 5 depicts a high level system diagram of a module status monitor in a battery module, according to an embodiment of the present teaching;

FIG. 6 is a flowchart of an exemplary process for monitoring status of a b, according battery module, according to an embodiment of the present teaching;

FIG. 7 depicts an exemplary high level system diagram of a self-initiating service unit in a battery module, according to an embodiment of the present teaching;

FIG. 8 is a flowchart of an exemplary process of self-initiating battery module service, according to an embodiment of the present teaching;

FIG. 9 provides an exemplary construct of a battery module service request, according to an embodiment of the present teaching;

FIG. 10A depicts an exemplary high level system diagram of a battery pack service management controller in a battery pack, according to an embodiment of the present teaching;

FIG. 10B is a flowchart of an exemplary process of a battery pack service management controller, according to an embodiment of the present teaching;

FIG. 11A provides an exemplary construct of a battery pack service reques, according to an embodiment of the present teaching;

FIG. 11B illustrates an exemplary construct of a service instruction, according to an embodiment of the present teaching;

FIG. 12 depicts an exemplary high level system diagram of a battery/application coordinator in a battery pack, according to an embodiment of the present teaching;

FIG. 13A shows an exemplary scenario in which a moving vehicle is directed by its battery towards a battery service center designated for providing needed battery service, according to an embodiment of the present teaching;

FIG. 13B illustrates an exemplary navigation interface through which a user of a moving vehicle can elect to approach a designated battery service center, according to an embodiment of the present teaching;

FIG. 13C shows an exemplary scenario in which a mobile battery service is called upon by a smart battery for house service, according to an embodiment of the present teaching;

FIG. 14 is a flowchart of an exemplary process of battery/application coordinator, according to an embodiment of the present teaching;

FIG. 15 depicts a high level framework for self-initiated battery service request and management in moving vehicle applications, according to an embodiment of the present teaching;

FIG. 16A illustrates different applications in which the battery self-initiated service may be deployed, according to an embodiment of the present teaching;

FIG. 16B illustrates different types of moving vehicles application scenarios in which battery self-initiating service request and management can be deployed, according to an embodiment of the present teaching;

FIG. 16C illustrates different types of portable device application scenarios in which battery self-initiating service request and management can be deployed, according to an embodiment of the present teaching;

FIG. 16D illustrates different types of equipment application scenarios in which battery self-initiating service request and management can be deployed, according to an embodiment of the present teaching;

FIG. 16E illustrates different types of instrument application scenarios in which battery self-initiating service request and management can be deployed, according to an embodiment of the present teaching;

FIG. 17A depicts a high level system diagram of a battery service center, according to an embodiment of the present teaching;

FIG. 17B is an exemplary construct of a service completion confirmation, according to an embodiment of the present invention;

FIG. 18 is a flowchart of an exemplary process in which a battery service center provides on-demand service in response to battery self-initiated service requests, according to an embodiment of the present teaching;

FIG. 19 depicts an exemplary system diagram of a post service handling unit at a battery service center, according to an embodiment of the present teaching;

FIG. 20 is a flowchart of an exemplary process of a post service handling unit at a battery service center, according to an embodiment of the present teaching;

FIG. 21 depicts an exemplary high level diagram of a battery service central control center, according to an embodiment of the present teaching;

FIG. 22 depicts an exemplary system diagram of a service request handling unit, according to an embodiment of the present teaching;

FIG. 23 depicts the architecture of a mobile device which can be used to implement a specialized system incorporating the present teaching; and

FIG. 24 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure generally relates to systems, methods, medium, and other implementations directed to an improved battery that is modular in construct, intelligent and self-aware in functionality, and capable of self-detection and self-initiating battery related services when needed in a proactive manner. The improved battery is modular as each battery module has known physical pose, peripheral circuitry, battery status self-monitoring, and module battery service management controller for initiating battery module service request. Each module has its own constructive pose within a pack and is packaged in a manner to enable easy detachment and re-attachment to facilitate automated, and hence faster, replacement of battery modules via a robot arm configured based on well-defined pose of each module. The peripheral circuit and battery status monitoring mechanism associated with each module enables detection of problems of individual modules.

The self-initiating service management of each battery pack is capable of requesting a needed service remotely via network connections, processing a service instruction from a responding battery service center, coordinating with the application the battery is deployed therein for receiving the requested service. According to the present teaching, when deployed in a moving vehicle, the improved smart battery, as disclosed herein, is capable of analyzing a service instruction received from a service center in order to coordinate, according to the service instruction, with, e.g., the navigation system of the moving vehicle to guide the vehicle to the service center for needed battery services.

A different aspect of the present teaching is a battery service framework in which each battery module is capable of self-monitoring and self-initiating a service request to a geographically distributed battery service center network. Either a battery service central control center or individual service centers in the service network can respond to a battery self-initiated service request, scheduling the requested services.

Another aspect of the present teaching is a battery service network capable of responding to a self-initiated service request from a smart battery by scheduling the service, automatically configuring, based on the received service request, necessary resources at the service center for designated services, as well as the geographical location of the battery that requires the service. In moving vehicle applications, such resources include a service center appropriate for each particular situation, tracks for a moving vehicle to pull in for the service, robot arms configured according to the pose of a battery module that is to be serviced, etc.

Yet another aspect of present teaching is the centralized battery management, in terms of battery maintenance, service, and deployment. Each battery can be uniquely identified and each of its maintenance and deployment may be archived. Replaced batteries can be grouped in collection for re-conditioning and re-conditioned batteries may be re-deployed in appropriate applications, all being done in an organized and managed fashion within a battery service network. Battery re-conditioning and re-deployment may be done collectively, e.g., at a service center, making it more efficient.

A different aspect of the present teaching is the ability of automatic metering and determination of service charge. Each battery module may have its own metering system that obtains various readings of the module such as power or capacity. At the time of a battery, a reading from the replaced battery is compared with a corresponding reading of the replacing battery to automatically determining the service charge. For example, if a battery module is to be replaced doe to, e.g., a low power reading, the metering system of the battery module provides a reading of the current status of the battery (e.g., level of the power of the replaced battery) and this reading is compared with that of the power reading of the replacing battery and the difference between the two readings is the basis of a automatically determined service charge.

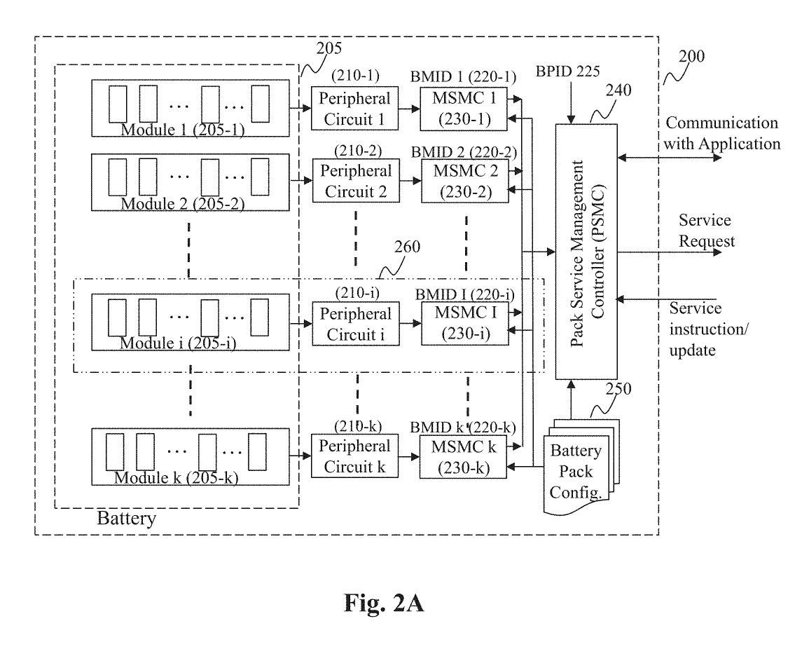

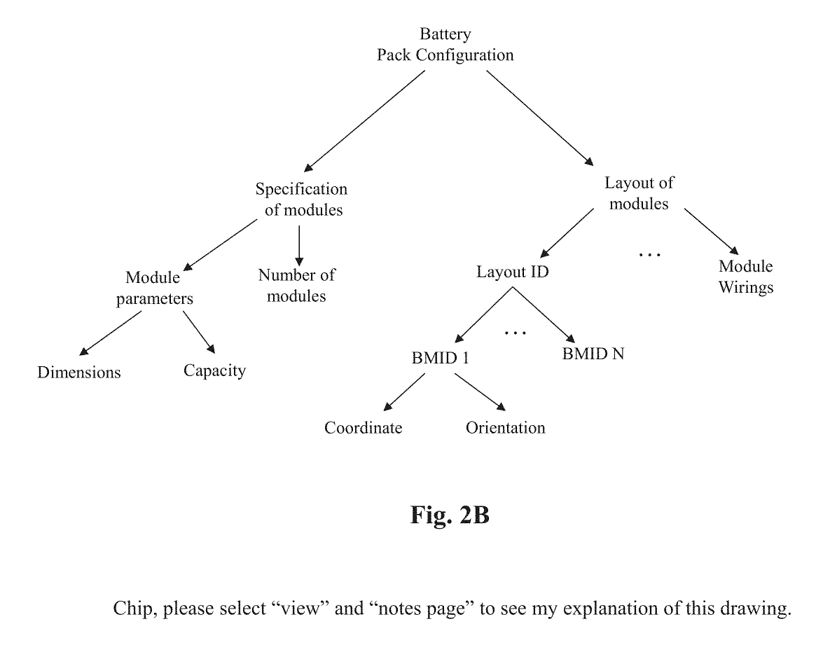

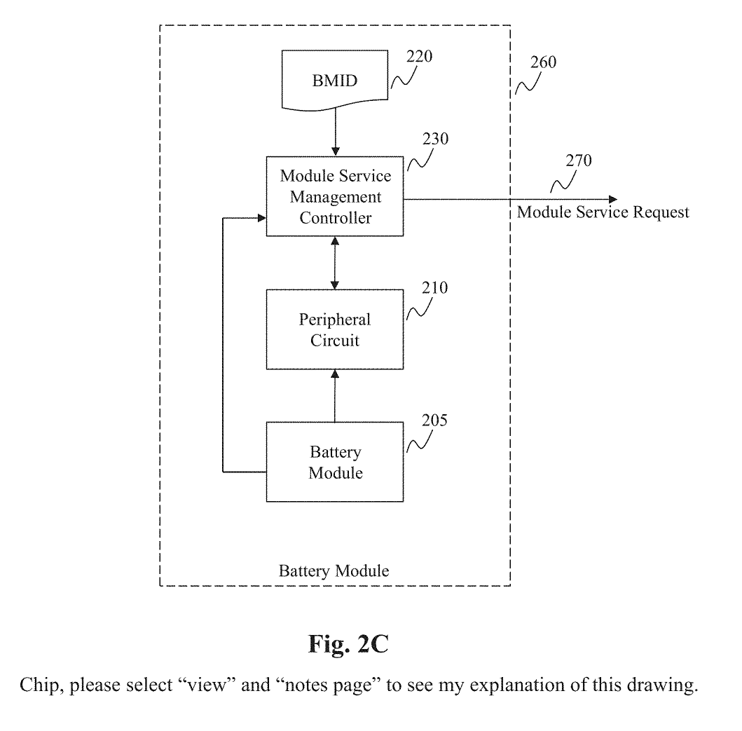

FIG. 2A depicts an exemplary improved modular battery system 200 that is constructed to be able of monitoring individual modules for battery status and self-initiating a request for needed battery service, according to an embodiment of the present teaching. The modular battery system 200 comprises a battery pack 205 which includes multiple battery modules 205-1, 205-2, . . . , 205-i, . . . , 205-k. Individual battery modules have their own corresponding peripheral circuits 210-1, 210-2, . . . , 210-i, . . . , 210-k and module service management controllers (MSMC) 230-1, 230-2, . . . , 230-i, . . . , 230-k. For example, module 260 is a module construct including a battery module 205-i, a corresponding peripheral circuit 210-i responsible for battery module 205-i, and MSMC i 220-i for monitoring the status of battery module 205-i and for initiating a request for battery service when deemed needed. Each module construct (e.g., 260) has a unique identifier Battery Module Identification or BMID. For instance, the k modules of battery pack 200 have corresponding identifiers BMID 1 220-1, BMID 2 220-2, . . . , BMID i 220-i, . . . , and BMID k 220-k. Such identifiers may be designed to unique identify each battery module.

In FIG. 2A, each of the MSMCs is connected to a pack service management controller (PSMC) 240 and through the connection, any battery module or MSMC in the pack 200 may send a request to the PSMC 240 for a service related to the corresponding battery pack. Each request from a module may be sent with its BMID to the PSMC 240. The battery pack 200 also includes a battery pack configuration 250 which records information on how the battery modules in the pack are organized or configured. This information may indicate the construct of the pack such as the number of modules and the location of each in the pack as well as other parameters. With a BMID in a module service request, the PSMC 240 may determine the location of a battery module that requires service. In addition, the battery pack 200 is also identified based on a battery pack identifier BPID 225 that may be designed to uniquely define a battery pack. Upon receiving a module service request from one or more modules, the BPMC 240 may determine whether to initiate a service request for the battery pack with a battery pack identification and the information indicative of which module(s) in the pack that need the requested service(s).

FIG. 2B provides an exemplary battery pack configuration 250, according to an embodiment of the present invention. As there are multiple modules in a battery pack, the battery pack configuration is to provide information about the individual component modules, their structural and functional parameters, and connections thereof. For example, as illustrated in FIG. 2B, the battery pack configuration 250 may include specification of the component modules and the construct of the component modules. The specification of the modules may indicate required component level requirement such as the number of modules and parameters of each of the component modules, which may be related to the physical dimension of each module as well as some functional parameters of the module such as the capacity. The construct or layout of the component modules may be described by, e.g., the spatial arrangement of the component modules and connections among the modules. For example, when the constructs of battery packs can be standardized, the description of a specific layout of a particular battery pack may be specified using an identifier representing the specific layout. In each specific layout, there are multiple component modules each having a unique identifier BMID and a pose in space which may be specified based on, e.g., a relative coordinate and a relative orientation with respect to a particular reference point. Component modules in a pack may also be wired in a certain manner and that information may also be provided in the battery pack configuration 250. Through the battery pack configuration, the pose of each component module may be identified.

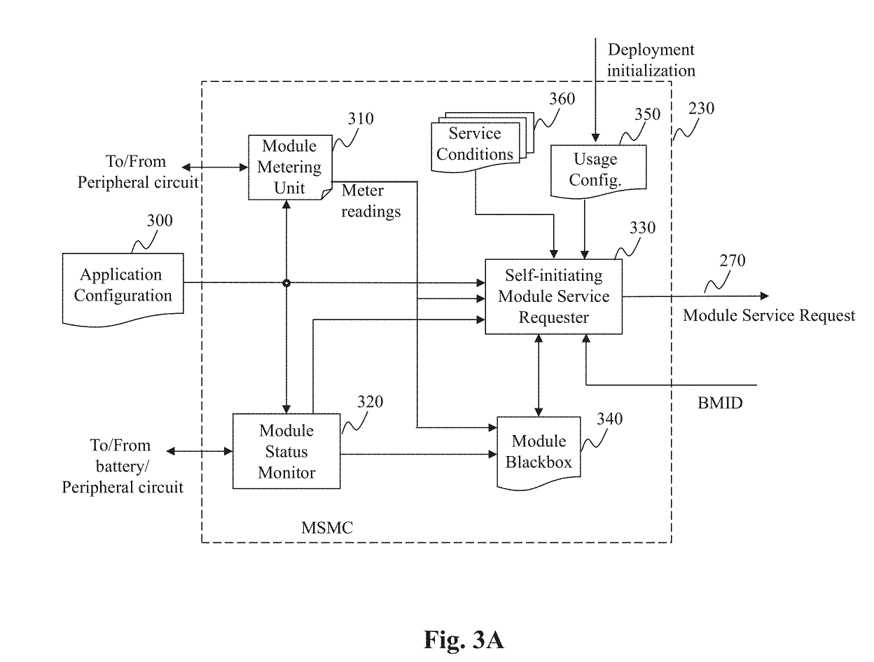

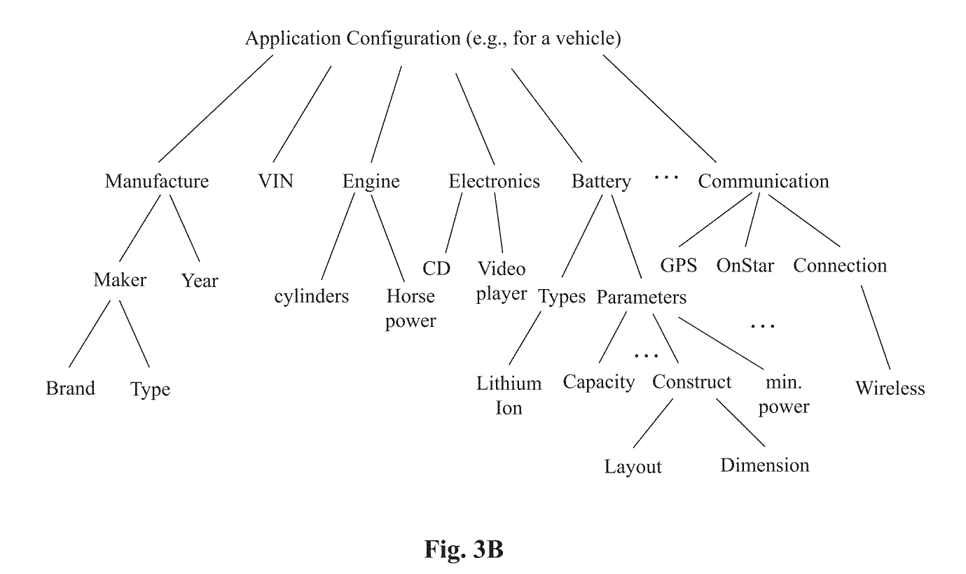

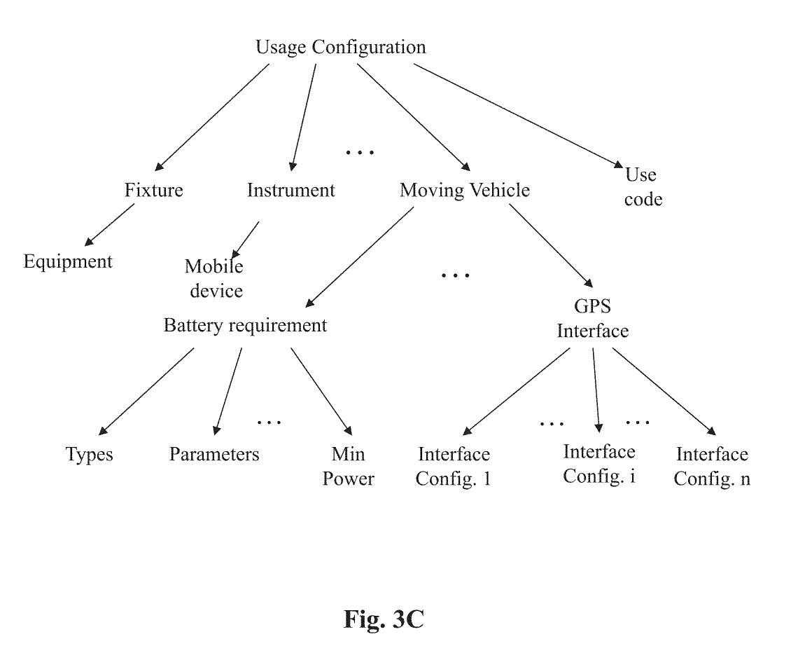

FIG. 2C depicts an exemplary construct of a battery module 260, according to an embodiment of the present invention. As discussed above, a battery module 260 includes a battery module 205, a peripheral circuit 210, and a module service management controller MSMC 230. The battery module 260 is associated with a BMID 220, which may uniquely identify the battery module 260. In operation, the peripheral circuit 210 is connected with the battery module 205 to perform different functions. The MSMC 230 may be connected to either of the battery module 205 and the peripheral circuit 210 to monitor the status of the battery module 205 and based on the monitored information, the MSMC 230 may send, when deemed as needed, a module service request 270 to the PSMC 240 for certain battery related service. The battery module 260, although wired with other battery modules in the pack 200, may operate independently in the pack and requests battery service based on the status of the monitored battery module. Details related to the MSMC 230 are provided below in reference to FIGS. 3-9.

FIG. 3A depicts an exemplary system diagram of the module service management controller MSMC 230, according to an embodiment of the present teaching. In this exemplary embodiment, the MSMC 230 comprises a module status monitor 320, a module metering unit 310, and a self-initiating module service requester 330. The module status monitor 320 is configured to monitor the status of the batteries in the module via the connection with the batteries and/or the peripheral circuit for the module. The module metering unit 310 may be configured to read certain parameters associated with the battery module such as the remaining level of power or current level of capacity of the module. Based on the monitored battery status information from the module status monitor 320 and the battery readings from the module metering unit 310, the self-initiating module service requester 330 may determine, whether the underlying battery module needs services. A battery module may need services for different reasons. For example, if the power level is low, the battery may need to be replaced (as opposed to re-charge in certain situations such as long distance drive). In some situations, a battery module may mal-function and need to be repaired. If battery service is deemed needed, the self-initiating module service requester 330 sends a module service request to the PSMC 240.

The determination of whether the module needs any service may be made based on additional information. For example, the application in which the battery module is deployed may have certain requirement on the battery and, hence, relevant in determining when a service is needed. Such application may be stored outside of the battery pack 200 and the protocol to access such information may be standardized or specified. In some embodiments, such application configuration may not exist or accessible. In such situations, the self-initiating module service requester 230 may make a decision independent of information related to specific requirement on battery from applications where the battery module is deployed.

FIG. 3B illustrates an exemplary application configuration for a moving vehicle, according to an embodiment of the present teaching. In this example, the application configuration includes information related to the vehicle, including the requirements on batteries it may use. The application configuration in FIG. 3B includes manufacturer of the vehicle, a vehicle identification number or VIN that uniquely identifies the vehicle, engine type, electronics included in the vehicle, the battery requirements, . . . , and the communication capabilities of the vehicle. Specifically, for the manufacturer, the configuration may specify the maker of the vehicle with specifically the brand or type of the maker, the year in which the vehicle was made. In specifying the engine information, it may be provided as to how cylinders the engine has or the horse power of the engine. For electronics, it may specify whether the vehicle has CD or video player. For communication capabilities, the application configuration may specify whether the vehicle has, e.g., GPS, OnStar system, or wireless connections.

The application configuration may also have specification on the requirements related to batteries. It may indicate the type of battery that can be installed (such as lithium ion battery) and required battery parameters such as required capacity, required minimum power level, or certain construct of the batteries such as layout or dimensions. Information related to batteries may be accessed by the self-initiating module service requester 230 in order to determine whether the battery module may need service.

When a battery module is deployed (or re-deployed after re-conditioning) in an application, it may be deployed in different applications. For example, it can be deployed in a moving vehicle or in an instrument or equipment. Depending on the deployment environment, when a service is needed for the battery module, the self-initiating module service requester 230 may request different types of service. For instance, if the battery module is deployed in a moving vehicle and the vehicle is currently on highway, the service needed in light of a lower power level is to quickly replace the battery module with a fully charged battery at a service center. In this case, a service request is to call for a service center along or nearby the highway so that the vehicle can be driven there for the replacement (much like getting gas at a gas station). On the other hand, if the battery module is currently deployed in an instrument or equipment as a fixture and had mal-functioned, the needed service for the mal-functioning battery module is to replace with a well-conditioned replacement battery. In this case, the service has to be house service so that a different service request has to be made so that service can be delivered to where the fixture is.

In some embodiment, the self-initiating module service requester 230 may access information stored in a usage configuration 350 (which may be stored in the battery module), which may include information about the environment in which the battery module is deployed. The information in the usage configuration 350 may be initialized or set when the battery module was deployed in the environment. FIG. 3C illustrates exemplary types of information in the usage configuration 350, according to an embodiment of the present teaching. It may indicate in which environment the battery module is deployed, including a use code (indicating whether it is deployed alone as a stand-alone battery or in combination with other modules in a battery pack), whether it is used in a fixture, in an instrument, or in a moving vehicle. Equipment may include a, e.g., a crane deployed in field. Instrument may include a mobile device, a medical equipment, etc. For each deployment environment, the usage configuration may provide detailed information related to that deployment environment. For example, if the deployment environment is a moving vehicle, the usage environment may also provide information about the specific application such as battery requirement or GPS interface parameters to facilitate the interface between the battery module and the moving vehicle. For instance, the battery requirement may provide information on type(s) of battery that can be deployed therein, parameters related to the battery, or the minimum power level required. Some of such information may be from the application and can be set up when the battery module is deployed in the application so as to facilitate the self-initiating module service requester 230 in determining the needed service, especially in absence of the application configuration.

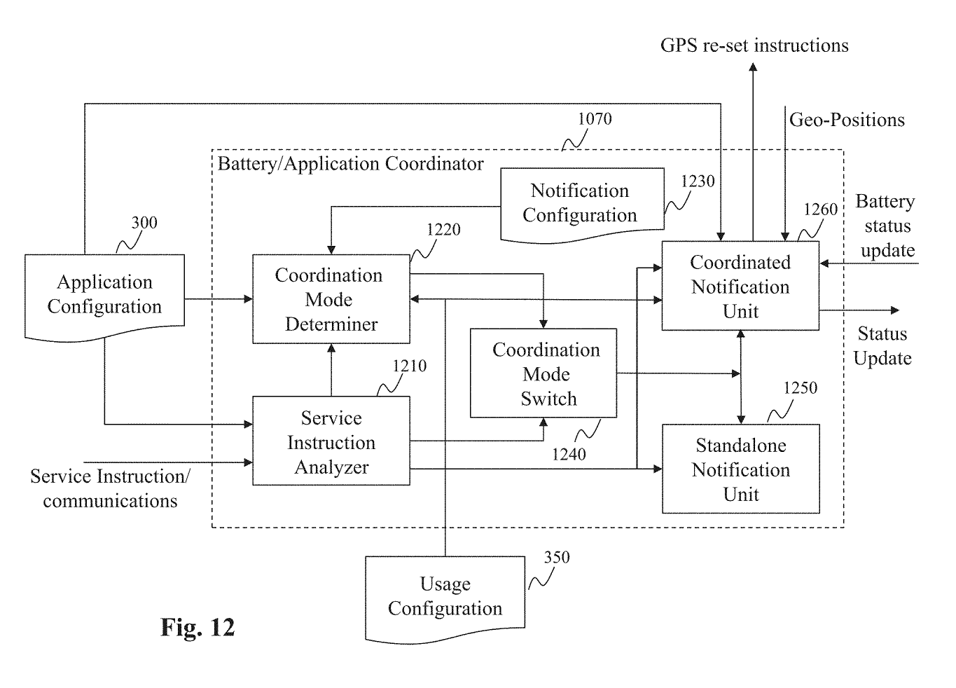

In a moving vehicle, information related to how to interface with a navigation system may be provided so that the battery module deployed may communicate with the navigation system to guide the vehicle to a service center for needed battery services. Such a navigation system may be internal to the moving vehicle or external thereto. In either situation, upon deployment, the protocol to communicate with the navigation system may be initialized via the usage configuration 350 so that the battery pack 200 may utilize. Details on how the battery pack 200 uses such information to guide a vehicle to a service center are provided in reference to FIGS. 12-14.

Based on information from the module status monitor 320, the module metering unit 310, the application configuration 300, and the usage configuration 350, the self-initiating module service requester 230 determines, based on service conditions 360, whether the battery module needs to be serviced (e.g., whether the power level of the battery is too low or whether the battery module is mal-functioning), what type of service is needed (replacement of a fully charged battery module or a well-functioned battery module), and what kind of service should be requested (drive-through service at a service center or house service). The service conditions 360 may store various conditions under which the battery module needs corresponding types of services and may be set at the time of deploying the battery module based on, e.g., the application and usage of the battery module. For example, if an application requires a minimum level of battery power to operate, then a threshold level of battery power may be set accordingly in the service conditions 360, which specifies that when the power level drops to the set threshold level, the battery module requires a replacement service.

When it is determined that battery service is needed, the self-initiating module service requester 230 generates a module request that is accordingly constructed with the corresponding BMID for the battery module with a request that is appropriate for the particular usage environment of the battery module. The service request is then sent by the self-initiating module service requester 230 to the PSMC 240.

In some embodiments, each battery module may also include a module blackbox 340, which records information related to the battery module on a regular basis. Each time, information obtained via the status monitor on the battery module is saved in the module blackbox 340. In addition, the readings from the module metering unit 310 are also saved in the module blackbox 340. Recorded information in the module blackbox 340 may provide a basis for determining how to re-condition the battery module upon being replaced. Then when the battery module is re-conditioned, the recorded information in the module blackbox 340 may be downloaded to a centralized archive under the unique identifier BMID and the status of the re-conditioned battery module may then be stored in the module blackbox 340 as re-initialized information about the battery module. In this way, the history of the battery module is continuously archived without consuming too much space of the module blackbox on the module to be efficient.

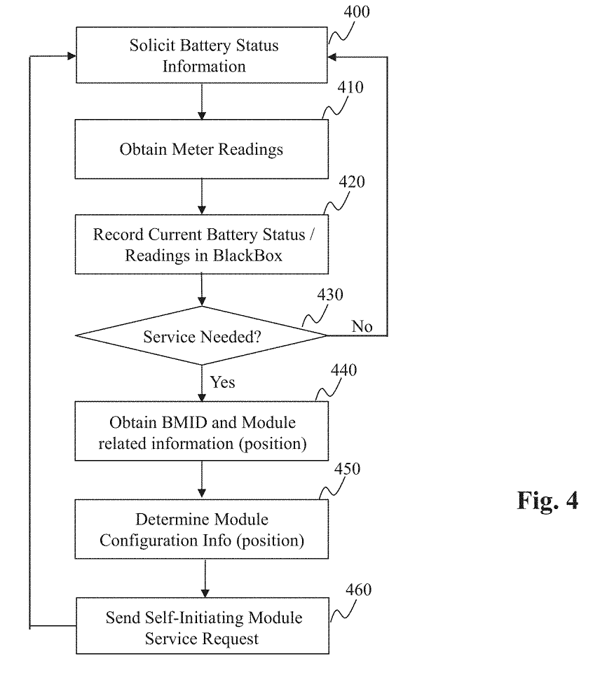

FIG. 4 is a flowchart of an exemplary process of the self-initiating module servicer requester 230, according to an embodiment of the present teaching. At 400, battery status information is solicited by the module status monitor 320. The module metering unit 310 obtains, at 410, various readings of different parameters associated with the battery module. The status information and the readings from the battery module are stored, at 420, in the module blackbox 340 and analyzed to determine, at 430, whether the battery module needs some service according to the service conditions set in 360. If no service is needed, the operation goes back to 400 to continually check, at 400, the status and obtains, at 410, various battery readings. If service is needed, BMID for the battery module is obtained and the pose of the module is determined at 440. Such information is used to generate a module service request and sent by the self-initiating module service requester, at 450, to PSMC 240, with the information stored in the module blackbox 340 at 460.

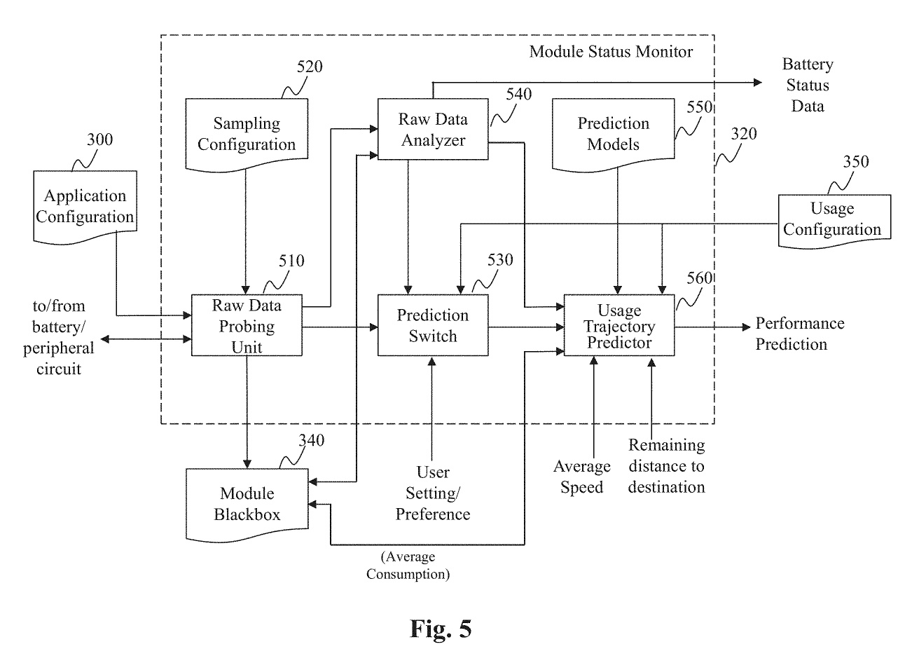

FIG. 5 depicts an exemplary system diagram of the module status monitor 320, according to an embodiment of the present teaching. As discussed herein, the module status monitor 320 is to gather information related to status of a battery module and this is performed as part of the monitoring the module. In this embodiment, the module status monitor 320 comprises a raw data probing unit 510, which probes the module in accordance with a sampling configuration 520, a raw data analyzer 540, a prediction switch 530, and a usage trajectory predictor 560. The raw data probing unit 510 may be configured to connect to the module and/or the peripheral circuit of the module to gather data from either the peripheral circuit or from the module directly. The raw data probing unit 510 may operate based on parameters from, e.g., the sampling configuration 520 and/or from the application configuration 300. For instance, depending on the application in which the module is deployed, the probing may be performed with respect to different parts of the application such as either the battery module or its peripheral circuit. In addition, the probing may be done in accordance with some sampling frequency determined based on configuration parameters stored in the sampling configuration 520. Examples of battery status information include voltage level, capacity, power density, or charging state of the battery module.

The sampled raw data may be stored in the module blackbox 340 and may also be analyzed by the raw data analyzer 540 to derive battery status data. The analysis may be done on the sampled data or in combination with the previously sampled data as a time series. When analyzed in combination with previously sampled data, the raw data analyzer 540 may retrieve previously sampled data from the module blackbox 340. The raw data analyzer 540 derives the battery status data from the analysis and outputs such battery status data to the self-initiating module service requester 330, as shown in FIG. 3A. The derived battery status data may also be stored back in the module blackbox 340.

In some embodiments, in certain applications such as moving vehicles, such derived battery status data may further be used to estimate how the battery status may impact the performance of the moving vehicle. For instance, the battery status data may be used to predict the distance that the vehicle can drive given the status of the battery. In this case, the prediction switch 530 determines, based on the usage configuration 350 or some preference that the user of the application has set, whether further estimation on how the battery status impact the performance of the application needs to be performed. For example, if the usage configuration 350 indicates that the battery module is deployed in a moving vehicle, the prediction switch 530 may proceed to activate the usage trajectory predictor 560 to estimate, e.g., how many more miles the moving vehicle can drive given the status of the battery module. The prediction switch 530 may also act according to the preference set by the user. For instance, even if the usage configuration 350 specifies that the application of the module is a moving vehicle, the driver of the vehicle may set the preference not to estimate how the vehicle performance will be impacted by the battery status. In this case, the prediction switch 530 may not activate the usage trajectory predictor 560.

The usage trajectory predictor 560, once activated by the prediction switch 530, may proceed to estimate the performance of the vehicle based on information from different sources. For example, the usage trajectory predictor 560 may access prediction models 550 based on which the prediction is to be made. It may also access information from the vehicle, e.g., the average speed the driver is driving, the remaining power (e.g., either from the raw data analyzer 540 or from the module blackbox 340) or the remaining distance to a set destination (e.g., from the GPS on the vehicle), in order to determine how does the current battery status impacts the expected performance of the vehicle. The usage trajectory predictor 560 may derive performance prediction and outputs such prediction to the self-initiating module service requester 330. Such performance prediction may be the number of miles the vehicle can continue to drive without having issues or whether the current battery may allow the driver to get to the destination set.

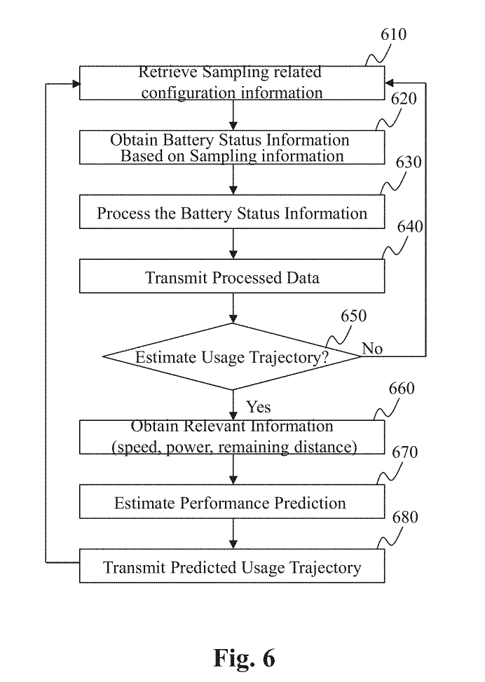

FIG. 6 is a flowchart of an exemplary process of the module status monitor 320, according to an embodiment of the present teaching. Sampling related configuration information is retrieved at 610. The battery status information is obtained, at 620, based on the sampling configuration information. Such obtained battery status information is then processed at 630 to derive battery status data, which is then transmitted, at 640, to the self-initiating module service requester 330. The prediction switch 530 then determines, at 650, whether usage trajectory is to be estimated. If no usage trajectory estimate is to be obtained, the module status monitor 320 returns its processing to 610 to continue to sample the status information. If the usage trajectory estimate is to be carried out, the prediction switch 530 activates the usage trajectory predictor 560, which obtains, at 660, relevant information for the prediction such as average speed, remaining power, or remaining distance to the expected destination. Based on the accessed information, the usage trajectory predictor 560 estimates, at 670, the performance prediction and then transmits, at 680, such estimated performance prediction to the self-initiating module service requester 330.

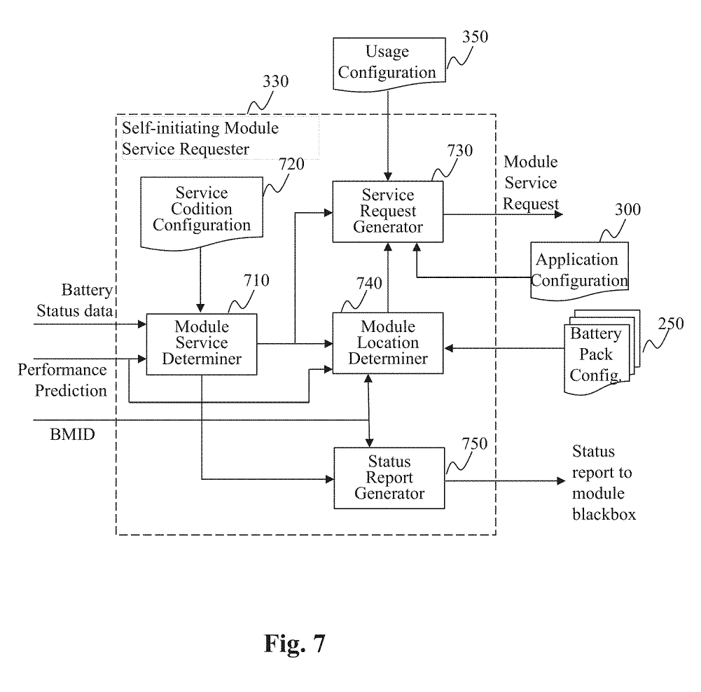

FIG. 7 depicts an exemplary system diagram of the self-initiating module service requester 330, according to an embodiment of the present teaching. The self-initiating module service requester 330 may be configured to determine, given the battery status data, whether the battery module requires services and if so, initiating a module service request to the battery pack. In this exemplary embodiment, the self-initiating module service requester 330 comprises a module service determiner 710, a module location determiner 740, a status report generator 750, and a service request generator 730. In operation, when the battery status data and/or performance prediction are received by the module service determiner, it decides, based on service condition configuration 720, whether battery service is needed. The service condition configuration 720 may archive various conditions under which batter service may be needed. For example, the service condition configuration 720 may include or specify that whenever the battery power drops to a certain level, battery service is needed. As another example, the service condition configuration 720 may also include a condition for service that is related to the rate of power drop of the battery. If the drop rate is above a certain threshold, the service condition configuration 720 may specify that a service has to be requested.

If it is determined that the underlying battery needs a service, e.g., the battery needs to be replaced due to lower power level, the module service determiner 710 may activate the module location determiner 740 and the service request generator 730. The module location determiner 740 may be configured to determine the pose of the battery module (e.g., the coordinate of the battery module relative to a reference point of the battery pack including the battery module) based on the identifier BMID of the module as well as the battery pack configuration 250. The service request generator 730 may be configured to generate a module service request based on information from different sources, including the battery status data from the module service determiner 710, the module pose information from the module location determiner 740, relevant information from the usage configuration 350 (e.g., minimum power level required for the usage), and/or information from the application configuration 300 (e.g., type of replacement battery needed).

The module service determiner 710 may also activate, e.g., whether a service is to be requested or not, the status report generator 750, which may be configured to generate a report on the determination status on whether to call for a battery service together with, e.g., the identifier BMID and/or data supporting the determination. Such a status report may also be transmitted to the module blackbox 340.

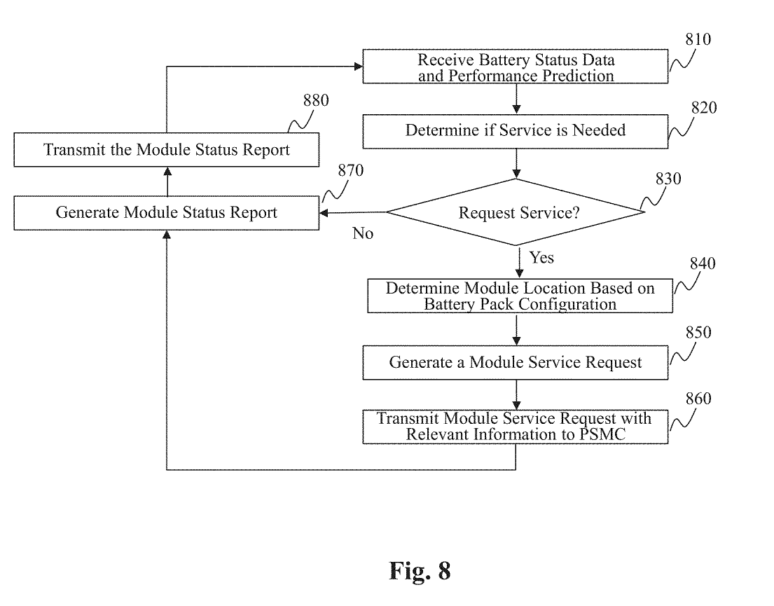

FIG. 8 is a flowchart of an exemplary process for the self-initiating module service requester 330, according to an embodiment of the present teaching. Battery status data and/or performance prediction are received at 810. Based on the received information, the module service determiner 710 determines, at 820, whether a service is needed for the battery module in accordance with, e.g., information archived in the service condition configuration 720. If a service is needed, determined at 830, the module service determiner 710 activates several functional blocks. This includes the activation of the module location determiner 740, which determines, at 840, the pose of the module based on identifier BMID and the battery pack configuration 250. The activation also includes the service request generator 730, which generates, at 850, a module service request and transmits, at 860, the generated request to the PSMC 240. Further, the module service determiner 710 may also activate the status report generator 750, which then generates, at 870, the module status report and then transmits, at 880, the module status report to the module blackbox 340. When it is determined, at 830, that no service is to be requested, the module service determiner 710 activates the status report generator 750, which similarly generates, at 870, the module status report and then transmits, at 880, the module status report to the module blackbox 340.

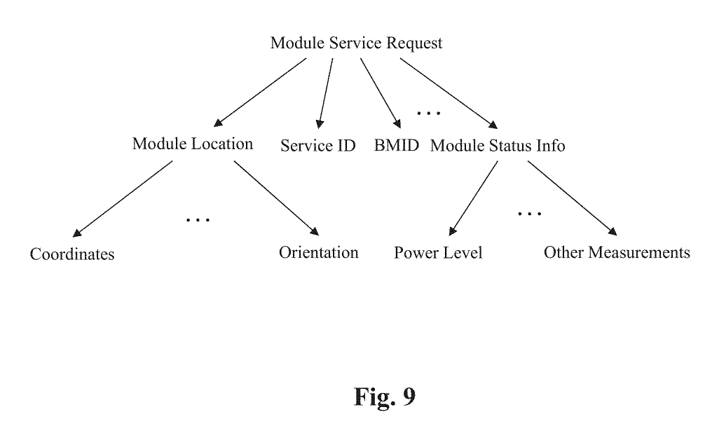

FIG. 9 illustrates an exemplary construct of a module service request, according to an embodiment of the present teaching. In some embodiments, a module service request may be sent from a battery module to a battery pack, where the module service request is used to determine whether a service request at the pack level is to be generated. In some embodiments, a battery module may be used as a stand-alone battery (instead of being a module in a battery pack) and in those situations, a module service request may be used directly as a battery service request. In this exemplary illustration, a module service request may include a BMID representing a unique identification of the battery module, a service ID signifying the type of service needed, module location indicating the location of the module (if in a pack, it may be a pose (coordinate or orientation of the module) relative to a reference point of the pack or a coordinate relative to a reference point of the application assembly if used as a stand-alone battery), . . . , and the current module status information. Other types of information may also be included in the module service request (not shown), including whether it is used as a stand-alone battery or in a battery pack.

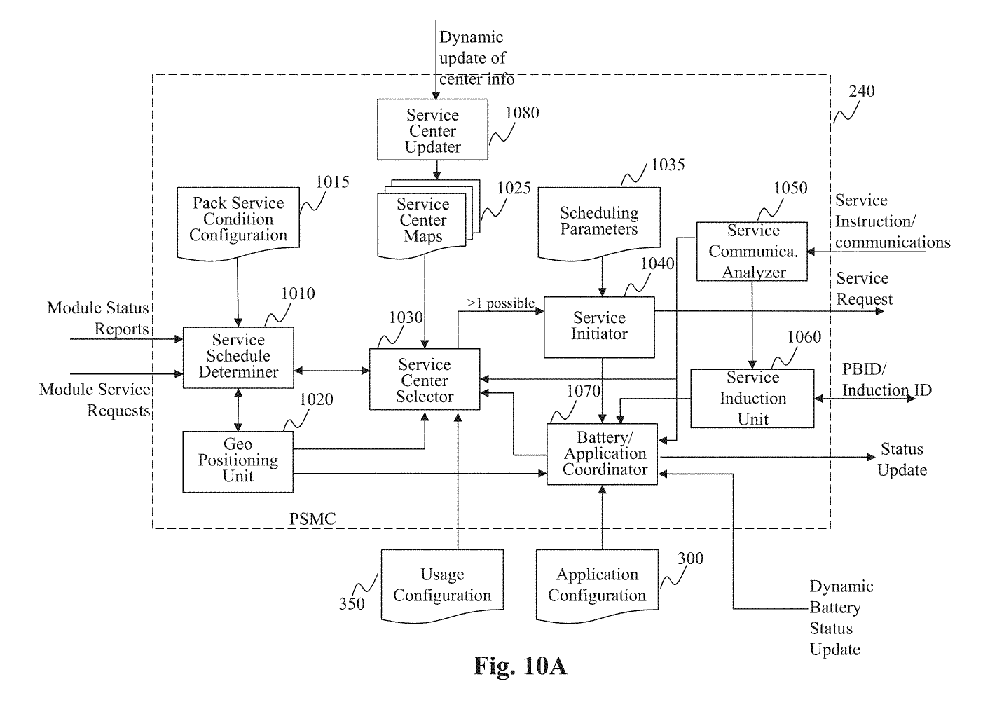

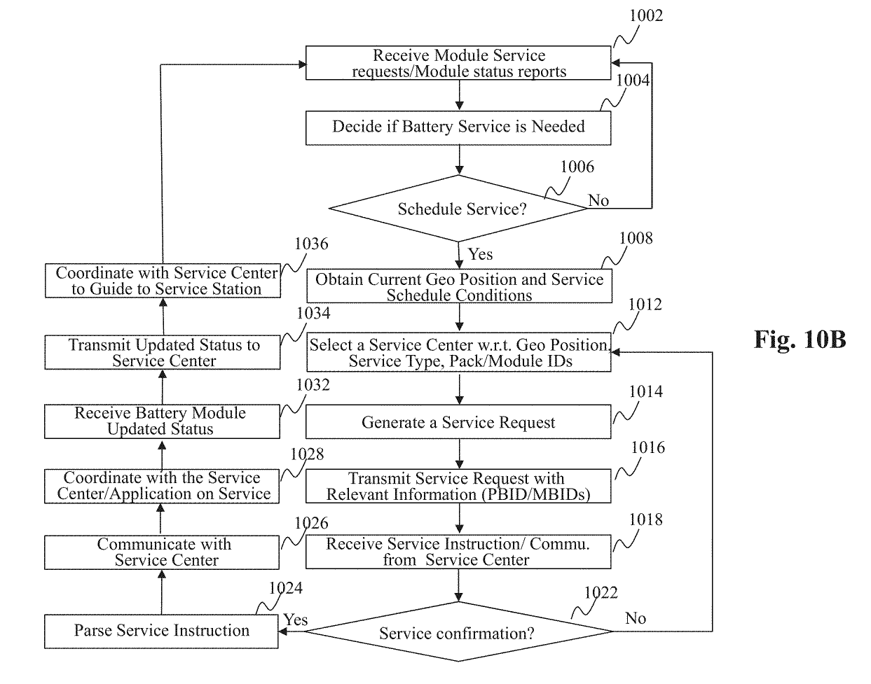

When a battery module in a battery pack requires service, the module service request from the corresponding self-initiating module service requester is sent to the PSMC 240, where a further determination may be made as to whether a service request at the pack level is to be issued. FIG. 10A depicts an exemplary system diagram of the PSMC 240, according to an embodiment of the present teaching. In this exemplary embodiment, the PSMC 240 comprises a service schedule determiner 1010, a geo positioning unit 1020, a service center selector 1030, a service initiator 1040, a service communication analyzer 1050, a service induction unit 1060, a battery/application coordinator 1070, and optionally a service center updater 1080. The service schedule determiner 1010 may be configured to determine whether one or more module service requests may lead to a service request at the pack level. The determination may be made based on various inputs as well as pack service condition configuration 1015, which may provide various conditions under which a pack level service request is to be made.

There may be different situations in which the pack service condition configuration 1015 specifies that one or more module service requests should trigger the PSMC 240 to initiate a battery service request. For instance, if there is a minimum requirement on power level at the pack level and the current status of the component modules is such that this minimum requirement cannot be met, the PSMC 240 may proceed to request battery service based on the one or more module service requests. As another example, if the configuration of the pack is such that a particular module is critically important to the operation of the pack (e.g., a module that is the bottle neck of the pack) yet currently this particular module requires battery service, the PSMC 240 may proceed to request battery service upon receiving the module service request from the particular module. Yet another example may be related to the availability of service centers. For instance, upon receiving the geo position of a moving vehicle employing the battery pack and locations of multiple available service centers, it is determined that, although the moving vehicle does not necessarily require service from the closest service center, the battery status will not support the vehicle to the next available service center, the PSMC 240 may also be instructed by the pack service condition configuration 1015 to initiate a service request to the closest service center.

In operation, upon receiving a module service request (and the corresponding module status report), the service schedule determiner 1010 may also obtain the geo position of the application (e.g., a moving vehicle which employs the battery pack) from the geo positioning unit 1020. The geo position may be a piece of important information, regardless of the type of application environment the battery pack is deployed. For example, if the battery pack is deployed in a car, it is important to know the current geo position of the car in order to automatically identify a nearby service center. When the battery pack is subsequently deployed in a heavy equipment located in the field, it is also important to know the geo position because that is where the house service to the battery pack needs to be delivered. The obtained geo position is used in a service request to a service center so that a house service team can be dispatched to the correct location for the service.

Based on the geo position and the pack service condition configuration 1015, the service schedule determiner 1010 decides whether the received module service request is to trigger a pack level service request. If it is determined to initiate a pack level service, the service schedule determiner 1010 activates the service center selector 1030 to select one or more service centers for the desired battery service. In some embodiments, the service schedule determiner 1010 may also first activate the service center selector 1030 to identify service centers around the known geo position of the battery pack and then determine, based on the selected service centers, whether and when a pack level service is to be initiated.

Once activated, the service center selector 1030 selects, from the available service centers listed in the service center maps 1025, one or more service centers based on the service requested by the modules (e.g., received from the service schedule determiner 1010) and the geo position of the battery pack. The service centers may be selected based on, e.g., whether a service center offers the type of service requested, the distance between the battery pack requiring the service and a service center, the speed at which the service can be delivered, and/or the price of the needed service. The selection may also depend on the usage of the battery pack. For instance, if a battery pack is deployed in a fixture so that the required service has to be delivered in-house, the selected service center corresponds to one that offers house services. In some embodiments, the service center selector 1030 may select more than one service center. In some embodiments, multiple selected service centers may be prioritized and the service management may be carried out in accordance with the priority among the selected service centers.

The information about distributed service centers stored in the service center maps 1025 may be dynamically updated over time via the service center updater 1080. Such update may be triggered by newly established service centers, any upgrade of service centers to include more service items, the change in what battery is in the stock of each service center, the types of applications each service center is capable of handling (e.g., whether can handle certain type of cars having a specific configuration in their battery construction), and/or the load of each service center.

Based on the selected service center(s), the service initiator 1040 may be activated, which may be configured to actually initiate the steps to receive the needed service from the selected service center(s). In some embodiments, the service initiator 1040 may proceed with retrieving some scheduling parameters stored in 1035 and generate a service request at the pack level based on such parameters. Examples of scheduling parameters include, e.g., identification of the service beneficiary (e.g., driver of a moving vehicle employing the battery pack or an organization that uses the battery pack in a fixture equipment in the field), billing information, and preferred payment method, etc. Such scheduling parameters may be set up at the time of the deployment (or re-deployment) of the battery pack.

The service request at the pack level, once generated, is sent by the service initiator 1040 to the selected service center(s) via network connections. The network may be a single network or a combination of different networks. For example, a network may be a local area network (LAN), a wide area network (WAN), a public network, a private network, a proprietary network, a Public Telephone Switched Network (PSTN), the Internet, a wireless network, a cellular network, a virtual network, or any combination thereof. A network may also include various network access points, e.g., wired or wireless access points such as base stations or Internet exchange points, through which a data source may connect to the network in order to transmit information via the network and a network node may connect to the network in order to receive information.

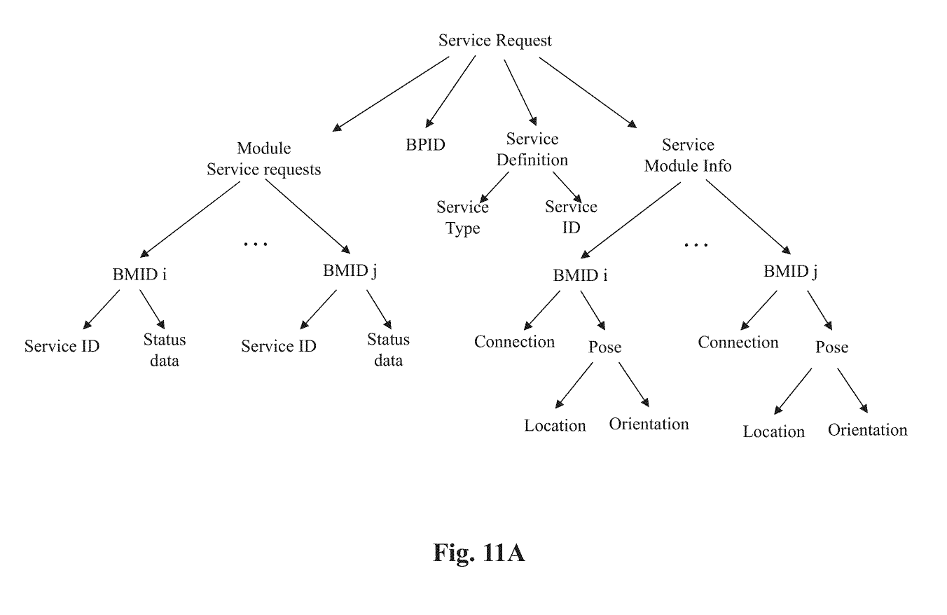

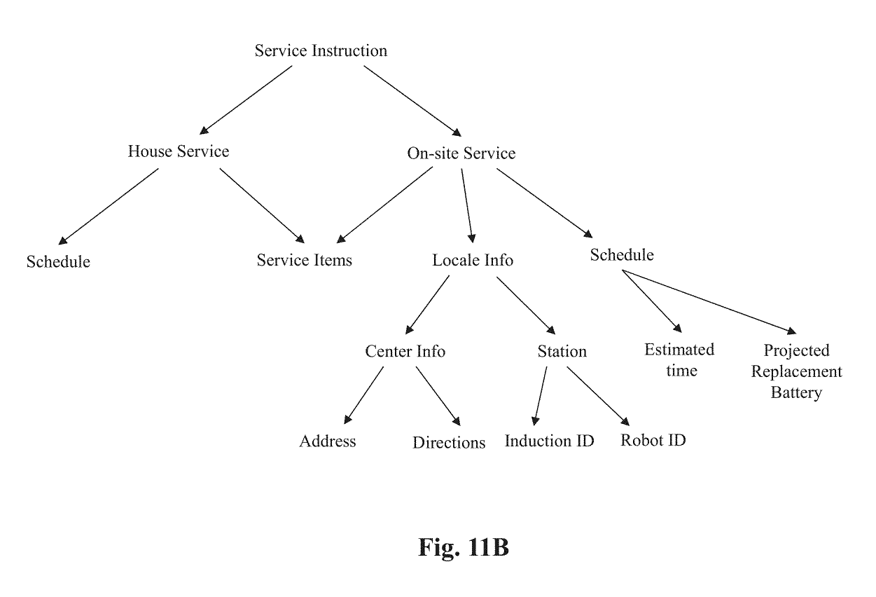

The service request at the pack level may include different types of information. FIG. 11A is an exemplary construct of a battery pack service request, according to an embodiment of the present teaching. In this exemplary embodiment, the service request at a battery pack level may include a BPID, a service definition, one or more module service requests, . . . , and service module information. The BPID to uniquely identifies a battery pack. The service definition may provide information related to the nature of the requested service. For instance, the service definition may include a service type which may indicate that it is an on-site service (e.g., a car driving through a service center for the battery service) or house service (e.g., the battery pack is in a fixture so that a service team needs to be called in to deliver the service). The service definition may also include a service ID, indicating the specific service needed. For example, the service ID may indicate what is needed is to replace a low power battery with a fully charged battery or the battery is defective so that an operational battery is needed. When more than one module in the pack need services, the service ID at the pack level may indicate that it is a combination service and the specific services for the modules may be individually determined in other part of the service request, as discussed below.

The service request at the pack level may also include specific information about individual module service requests, specifying, e.g., which module(s) in the pack needs what service. For example, in a pack, there may be two modules, e.g., module i and module j, that need service. In this case, the module service requests include descriptions of two module service requests, one for module i and one for module j, as shown in FIG. 11A. For each module request, the module service request may include a BMID uniquely identifying the battery module. For each BMID, the service request may include a service ID, indicating the service needed for that module, and some status data related to that module. Such status data may be used by the service center to determine, e.g., how to maintain the battery module after it is replaced.

The service request at the pack level may also include information about the constructional features of the modules which require service. Such constructional features may include, e.g., for each module requiring service, the location of the module identified by its pose, which may include a geographical location and orientation of the module relative to some reference point. The constructional features may also include information on how the module is connected to other modules in the pack. This is illustrated in FIG. 11A. Such information may be relied upon for delivering the service requested.

Once the service request is transmitted to the selected service center(s), the service communication analyzer 1050 may receive a response from the selected service center in responding to the service request, analyze the received information, and then forward different information to other functional units. The received response may correspond to a confirmation of the requested service. For example, a selected service center may acknowledge and confirm the requested service by sending to the PSMC 240 a service instruction. Depending on the nature of the service request, the service instruction may include different content. For instance, if the service requested is to be on-site at a selected service center, the service instruction from the acknowledging service center may include information on the specific track or location at the service center where the service is to be performed. In this case, the service instruction may also include an identification or electronic token to be used to be guided to the specific track or location at the service for the service. The service instruction may also provide information such as the time of the service, the estimated length of the service time, and/or the replacement battery to be used during the service.

FIG. 11B provides an exemplary construct of a service instruction, according to an embodiment of the present teaching. In this illustrated embodiment, the service instruction may indicate whether the service is an on-site service (at the service center) or a house service (service to be delivered to where the battery is), which may conform to the requested service, which may be a house service or an on-site service. Depending on the type of service confirmed (on-site or house service), the service instruction may further include appropriate types of information. For example, if the confirmed service is house service, the service instruction may provide a schedule (e.g., alternative dates and times) and specific service items (e.g., replacement battery is what type and with what conditions). If the confirmed service is on-site service, the service instruction may provide the locale information related to the service center as well as the schedule of the service. The locale of the service may include some specific information of the service center such as physical address of the service center and driving directions to the service center. The locale information may also include specific service station related information, such as some induction ID or token to be led to that particular service station and/or a robot ID, identifying the robot arm to be deployed to perform the service at the station. The schedule information related to the confirmed on-site service may include estimated length of time needed and the projected replacement battery to be deployed.

The service communication analyzer 1050 may parse a service instruction and direct different information to different functional units in the PSMC 240 in order to facilitate the process. For example, the service communication analyzer 1050 may forward the locale information relate to an on-site service to the battery/application coordinator 1070 so that the PSMC 240 may coordinate with the navigation system of the application (e.g., a moving vehicle) to detour to the selected service center. As another example, the service communication analyzer 1050 may also channel the received induction ID with the service instruction to the service induction unit 1060 so that the service induction unit 1060 may use that to communication with the service center upon arrival in order to be, e.g., automatically guided to the specific station or track assigned to deliver the requested service. For example, upon arriving the service center, the service induction unit 1060 in the PSMC 240 may present both the PBID and the received induction ID, e.g., wirelessly, to the service center. Based on the received PBID, the service center matches with the scheduled service and confirms that with the induction ID previously assigned to the pack via the service instruction. Upon confirmation, the service center may then guide the moving vehicle to the assigned station that matches with the induction ID.

For instance, if the battery pack is in a moving vehicle and the requested service is to be performed at a service center along a highway on which the moving vehicle is driven, the service instruction may serve to inform the battery pack the physical address of the service center, the driving directions from where the moving vehicle is, which service station or track at the service center is scheduled to perform the service, as well as an induction ID which the battery pack can use to communicate with the service center in order to proceed to the specific station scheduled to performed the service the pack needed. The robot arm identified by the robot ID may be assigned to the specific station and configured to perform the requested services based on the information communicated to the service center via the service request on which modules need service and the pose of each such module.

The selected service center may communicate with the PSMC 240 in the pack in response to the service request, indicating that it cannot deliver the requested service. In this case, the communication received by the PSMC 240 from the service center is analyzed by the service communication analyzer 1050. If needed, the service communication analyzer 1050 may inform the service center selector 1030, as shown via the connection between the service communication analyzer 1050, to select additional service center(s) in order to find next service center that can deliver the needed battery service. The process may repeat until a suitable service center is identified.

During the process of approaching a service center (or waiting for a house service), the PSMC 240 may continuously receive updated dynamic status information and transmit such dynamic information to the service center. For example, such dynamic status information may include the changing geo position of the battery pack (e.g., moves with the moving vehicle) as well as the battery status updates. Such dynamic information may be continuously collected by the battery/application coordinator 1070 from different sources and then transmitted to the service center as the dynamic status update of the battery pack.

FIG. 10B is a flowchart of an exemplary process of the PSMC 240, according to an embodiment of the present teaching. In this exemplary process, the PSMC 240 receives, at 1002, one or more module service requests and/or module status reports. Based on the information received from its components modules, the PSMC 240 decides, at 1004, whether a battery service request at the pack level is needed. As disclosed herein, the determination may be made based on the service schedule conditions stored in 1015 and/or the geo position of the pack. If a service at the pack level is not yet needed, determined at 1006, the PSMC 240 returns to wait for receiving information from its component modules at 1002.

If it is determined that a service request at pack level is to be sent, the PSMC 240 obtains, at 1008, its current geo position. Based on the geo position of the battery pack as well as other information (e.g., the type of service requested, the available service centers available), the service center selector 1030 selects, at 1012, one or more service centers to which a service request is to be sent. With the selected service center(s), the service initiator 1040 generates, at 1014, a service request and transmits, at 1016, the service request to the selected service center(s) with relevant information. Upon sending the service request, the PSMC 240 waits for a response.

When the service communication analyzer 1050 receives, at 1018, a response from the service center to which the service request is sent, it is determined, at 1022, whether the response corresponds to a service confirmation. If it is not a service confirmation (i.e., the service center cannot deliver the service), the service communication analyzer 1050 returns to 1012 to select additional service center(s). If the response is a service confirmation, the service response is parsed at 1024. Based on the parsed information, the PSMC 240 may optionally communicate, at 1026, with the responding service center. With the information received from the service instruction, the battery/application coordinator 1070 coordinates, at 1028, with the application such as the navigation system to use the service center address to detour to the service center. During the process of approaching the service center, the PSMC 240 may also gather, at 1032, updated battery status information and transmits, at 1034, to the service center. Upon approaching the service center, the service induction unit 1060 coordinates, at 1036, with the service center to proceed to the assigned service station for the scheduled service.

As discussed herein, the PSMC 240 communicates with the selected service center(s) to facilitate the delivery of the requested service. In some embodiments, the PSMC 240 also optionally coordinates with the application in which the battery pack is deployed. In some applications, such coordination may be merely presenting the information related to the scheduled service on the application, e.g., displaying that the battery service is scheduled on certain date and time, etc. Such coordination may also be more sophisticated. For example, if a battery pack is deployed in a moving vehicle, if the service is scheduled while the moving vehicle is driven on the road, the PSMC 240 may also be configured to coordinate with a navigation system, e.g., installed in the moving vehicle, to control the navigation to detour to the selected service center for the service. In this case, the address of the service center may be transmitted to the navigation system as a detour route. In some embodiments, the navigation system may also be external. Alternatively, the PSMC 240 itself may incorporate a navigation system that may work with, e.g., satellite to achieve positioning (not shown).

The battery/application coordinator 1070 is configured to perform the coordination between the battery pack and the application deploying the pack. FIG. 12 depicts an exemplary system diagram of the battery/application coordinator 1070, according to an embodiment of the present teaching. In this embodiment, the battery/application coordinator 1070 comprises a service instruction analyzer 1210, a coordination mode determiner 1220, a coordinator mode switch 1240, a standalone notification unit 1250, and a coordinated notification unit 1260. The service instruction analyzer 1210 is configured to extract information relevant to the battery/application coordination such as schedule for the service or address of the service center. The type of information to be extracted may depend on the application configuration which specifies the environment in which the battery pack is working. For example, if the application is equipment at a fixed location, there is no need to extract address of the service center because the requested service is likely a house service. If the application is a moving vehicle currently driving on the road and the application configuration indicates that the moving vehicle has its own GPS embedded therein, the service instruction analyzer 1210 may extract the address of the service center in the service instruction for the purpose of coordinating with the GPS to detour to the designated address for the service. Such communication with the GPA may be conducted based on, e.g., communication protocol that GPS uses which is accessed from the application configuration 300.

The service instruction analyzer 1210 may also invoke the coordination mode determiner 1220 to determine the mode by which the PSMC 240 is to communicate with the application. The coordination mode determiner 1220 may access information from the application configuration 300, the usage configuration 350, as well as the notification configuration 1230 to decide the current mode of coordination. In some embodiments, the coordination mode may depend on the usage type and/or the setting of the pack. For example, the application may be used in an instrument, which does not require to be informed of the battery service. In this case, the coordination mode may be set as doing nothing. In some usages, the notification may be performed with a merely indication, e.g., on the display screen of the application. For example, a battery pack may be deployed in equipment operating in the field. The scheduled service may be displayed on the screen of the equipment informing the user of the equipment. In other usages, the notification may be required to be sent to some centralized management destination such as an email address. For instance, when a battery pack deployed in equipment operating in the field needs to be replaced, the company providing the equipment may need to be notified via an email in order to log for the payment. Yet in other applications, the notification may be required to be provided with some unique sound to alert to a user of the application. For instance, if a battery pack is used in a hospital instrument deployed in emergency care, as the service may introduce certain interruption, the health provider at the hospital may need to be informed of such interruption so that certain measures may be adopted to prevent any problems. In the situation of a moving vehicle, the usage configuration 350 may provide specification of the protocols for communicating with the GPS in the moving vehicle to enable the battery/application coordinator 1070 to interact with the GPS to, e.g., detour the vehicle to the service center. This is illustrated in FIG. 3C.

Based on the coordination mode determined by the coordination mode determiner 1220, the coordination mode switch 1240 activates the standalone notification unit 1250 and/or the coordinated notification unit 1260 to effectuate the communication/coordination between the battery pack and the application. The standalone notification unit 1250 may be configured to merely deliver notification of the scheduled service in accordance with the configuration without having to coordinate with the application. On the other hand, if it is needed to actively communicating with the application and/or the service center to achieve coordination, e.g., control the GPS of a moving vehicle to take a detour to the service center, the coordination mode switch 1240 activates the coordinated notification unit 1260.

In some embodiment, the coordinated notification unit 1260 may be configured to communicate with the GPS of a moving vehicle to control the moving vehicle to take a detour to the service center. In this case, the coordinated notification unit 1260 obtains information related to the service center, e.g., the address and driving directions, from the service instruction analyzer 1210 (which extracts such information from the service instruction) and generates GPS re-set instructions. Such GPS re-set instructions are then sent to the GPS of the moving vehicle as a detour to whatever initially set destination. In some embodiments, the GPS may, when receiving the detour instruction, require the driver to manually confirm to accept. In some embodiments, the moving vehicle may be configured in such a way that a detour instruction from the battery pack does not need manual confirmation but the driver can manually interrupt it if needed.

In some embodiments, the coordinated notification unit 1260 also provides dynamic update related to the battery pack to the selected service center. To do so, the coordinated notification unit 1260 gathers, on a continuous basis, the current geo position as well as the battery status and sends to the selected service center as status update. Such status update may indicate degradation of the battery pack/module on the same problem reported previously or reveal newly occurred problems of the pack/module. Such status update, upon being received by the service center, may cause the service center to issue updated service instruction which may further cause adjustment within the pack. For example, if the dynamic status update reveals that a different module in the pack now has a different problem, the service center may now adjust the service to be provided to include the service for this module and accordingly, the estimated service time or even the service station may also be updated. In this manner, from the time to make a service request to the time to deliver the service, all issues in the battery pack that require service may be recorded and service scheduled accordingly.

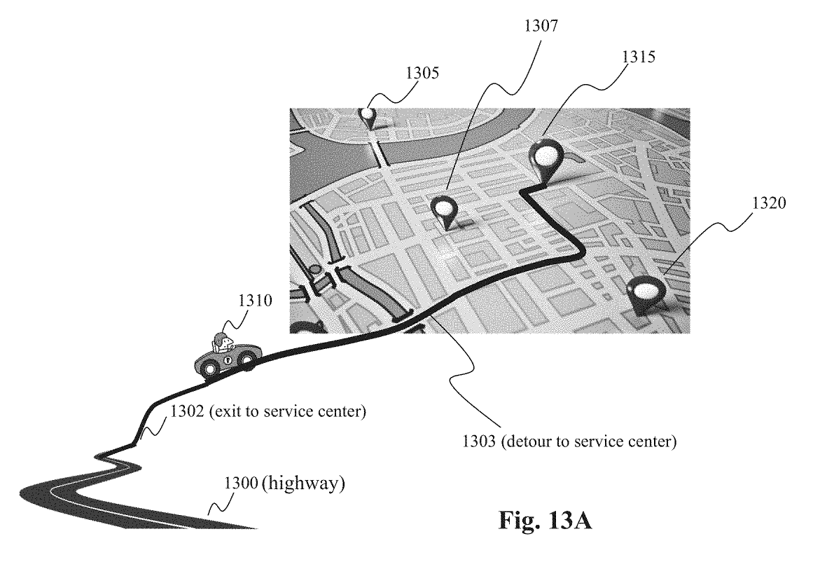

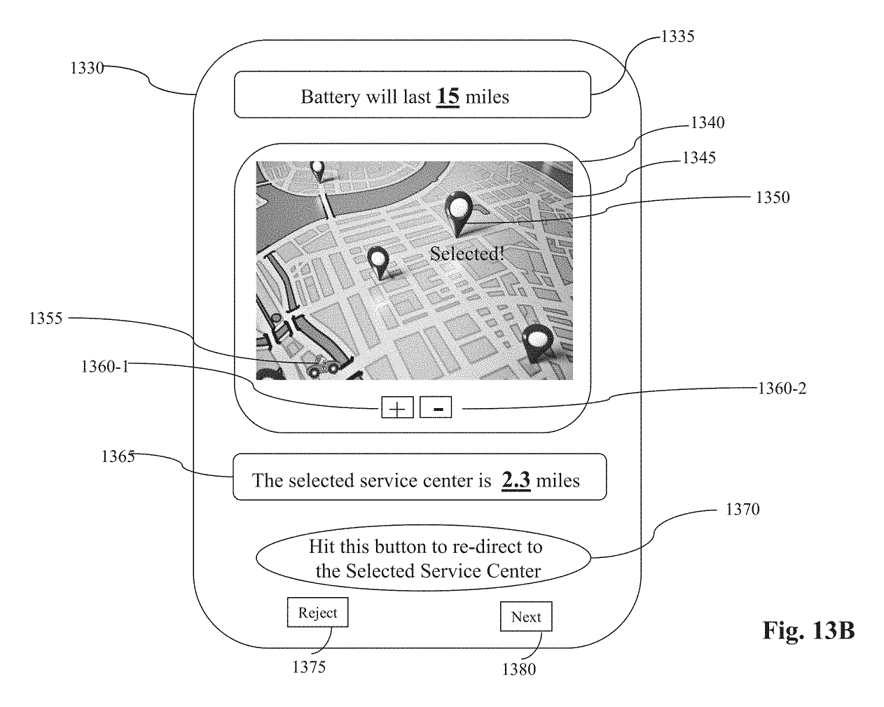

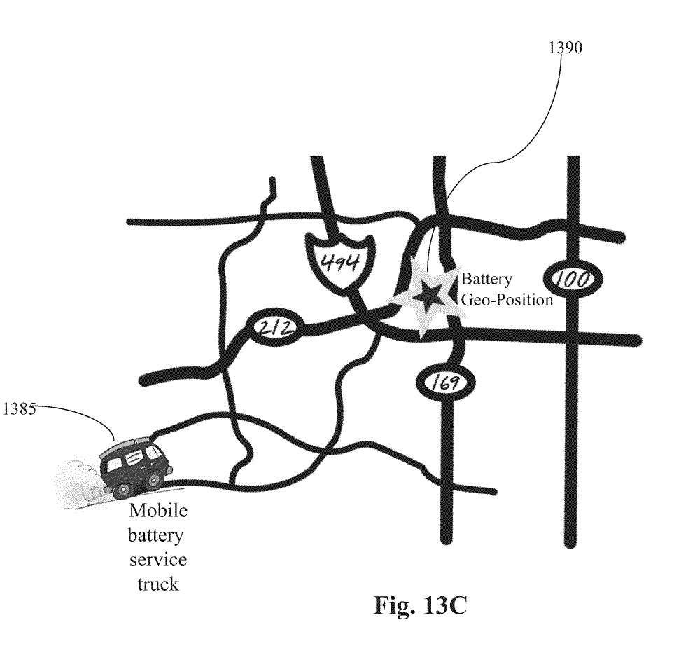

FIGS. 13A-13C illustrate different service scenarios, according to different embodiments of the present teaching. FIG. 13A shows a scenario in which the application of a battery pack is a moving vehicle 1310. The moving vehicle is initially driving on a highway 1305 and then the battery requires service. The battery pack in moving vehicle 1310 selects, among different nearby service centers 1302, 1307, 1315, and 1320, service center 1315 as the appropriate service center. That is, although service centers 1302, 1307, and 1320 are also nearby, they are not selected for various reasons, e.g., they do not provide the type of battery needed or type of service needed, etc. Once the service center 1315 is selected, the battery pack in moving vehicle 1310 sends a service request. When the service center 1315 responds to the service request, it sends a confirmation with a service instruction with various information e.g., the address of/driving directions to the service center, assigned service station, estimated service time/length, etc. Upon receiving the service instruction, the battery pack on moving vehicle 1310 parses the instruction and extracts the driving directions and sends a GPS re-set instruction to the GPS of the moving vehicle so that the moving vehicle takes exit 1302 from the highway according to the instruction and follow the detour 1303 towards the selected service center 1315. All these steps are carried out seamlessly and can be set automatically if the driver's manual confirmation of the detour is set not necessary. The interface of FIG. 13A may be displayed either on the moving vehicle or at the service center to visualize the distance between the moving vehicle and the service center. The geo position of the moving vehicle in FIG. 13A may also be dynamically updated according to the real time geo positions acquired by the battery pack.

FIG. 13B provides an exemplary interface in a moving vehicle that can be configured to facilitate battery/application coordination, according to an embodiment of the present teaching. The display 1330 represents a communication channel in a moving vehicle. The display may be configured, based on a choice of a driver, to serve as different interfaces. For example, the driver may select, e.g., via a button or a voice command, the display to function as a radio interface, a GPS interface, an Internet interface, a video playing interface, a music player interface, etc. (not shown). In some embodiments, the battery pack may automatically configure the display 1330 to become a special interface for reporting battery related issues/services. In FIG. 13B, an interface for reporting battery problems is illustrated.

In the interface shown in FIG. 13B, there are multiple window spaces each of which serves a different purpose. For instance, sub-window 1335 is a warning window, which displays a warning message “Battery will last 15 miles . . . ” in this example. Sub-window 1340 displays a map 1345 with 4 nearby battery service centers depicted with one marked as selected for the needed battery service. Also on the map 1345 in sub-window 1340, the current geo position of the moving vehicle 1355 is also marked. There are two exemplary buttons 1360-1 and 1360-2 which can be used to enlarge or shrink the map 1345. Alternatively, the display 1330 may correspond to a touch screen so that finger can be used to enlarge or shrink the displayed content.

Sub-window 1365 may be provided to display the information about the service center. For example, in this illustrated example, it is indicated that the selected service center is 2.3 miles from the current position. Sub-window 1370 is a actionable button with the display content “Hit this button to re-direct to the selected service center.” A hit on this button may serve as a confirmation to the automatic detour to the selected service center. There are also two smaller actionable buttons in sub-windows 1375 and 1380, corresponding to a button for rejecting the suggested detour to the selected service center and for selecting the next service center, respectively. Via this special interface triggered by the PSMC 240, the driver of the moving vehicle can be informed of the issue, the suggested resolution, and may determine whether the driver is going to accept the suggestion resolution to the battery problem.

FIG. 13C provides another exemplary scenario in which battery service is delivered to where the battery pack resides, according to an embodiment of the present teaching. In this example, a battery pack has a specific geo position 1390 on a map. Due to the nature of the application, the battery pack may require a house service. When the battery pack detects that a service is needed and sends a service request to a number of selected service centers (e.g., nearby). When a selected service center confirms the service, it sends the battery pack at 1390 a service instruction which indicates the date/time of the service and estimated length, etc. Upon receiving the service instruction, the battery pack at 1390 may send, if configured to do so, a notification to designated party. On the date of the scheduled service, a mobile battery service truck 1385 is sent on its way to the geo position of the battery pack 1390 to deliver the service. The map in FIG. 13C with the battery pack position marked (1390) and a dynamically updated location of the service truck 1385 may be displayed on a display screen of the application employing the battery pack and/or at the selected service center, if needed.

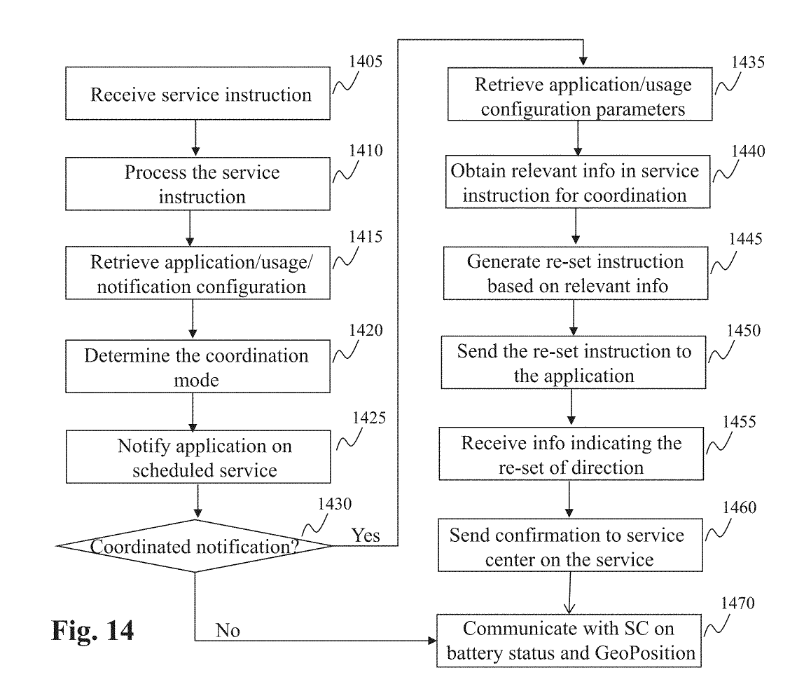

FIG. 14 is a flowchart of an exemplary process of the battery/application coordinator 1070, according to an embodiment of the present teaching. Upon receiving a service instruction at 1405, the service instruction analyzer 1210 processes, at 1410, the service instruction to extract relevant information. Application/usage/notification configurations are then accessed at 1415 and used to determine, at 1420, the coordination mode. In this exemplary process, the standalone notification unit 1250 is invoked to notify the scheduled service, at 1425, whether it is a coordinated notification mode or a standalone notification mode. In some embodiments, standalone notification may be carried out when it is not in a coordinated notification mode. At 1430, it is determined whether it is a coordinated or standalone notification mode. If it is a standalone mode, the standalone notification unit 1250 further proceeds to communicate, at 1470, between the application and the selected service center to provide updated battery status and the geo position of the application.

If it is a coordinated mode, determined at 1430, the coordinated notification unit 1260 retrieves, at 1435, various parameters from the application/usage configurations 300 and 350 and obtains, at 1440, relevant information extracted from the service instruction for coordinating with the application. Examples of such relevant information include address of and/or driving directions to the selected service center. For coordination, such extracted information is used to generate, at 1445 by the coordinated notification unit 1260, a (GPS) re-set instruction and such a (GPS) re-set instruction is then sent, at 1450, to the application. Upon receiving, at 1455, information from the application that (GPS) re-set is implemented, the coordinated notification unit 1260 sends, at 1460, a confirmation to the service center to confirm that the service is to be delivered there. The process then proceeds to continue to communicate, at 1470, between the application and the selected service center to provide updated battery status and the geo position of the application.

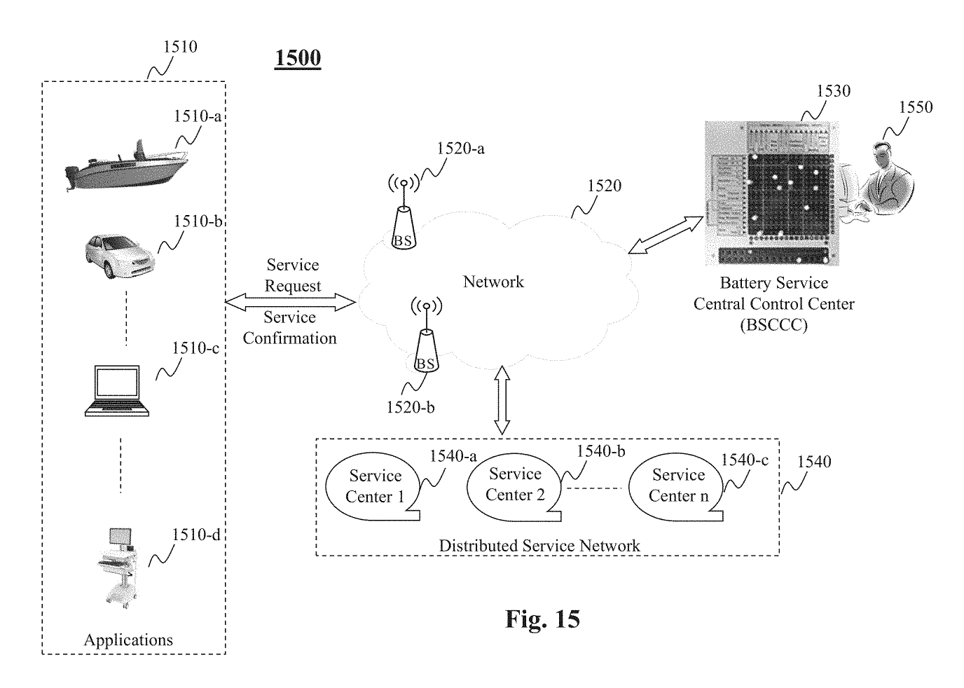

In the above disclosure, the communications from battery modules/packs are directed to service centers. In some embodiments, there is optionally a battery service central control center (BSCCC, which will be discussed in more detail with reference to FIGS. 15 and 21-22) and all or some service requests may be directed first to the BSCCC, which may then identify certain service center(s) appropriate for providing the requested services to the requesting battery modules/packs.

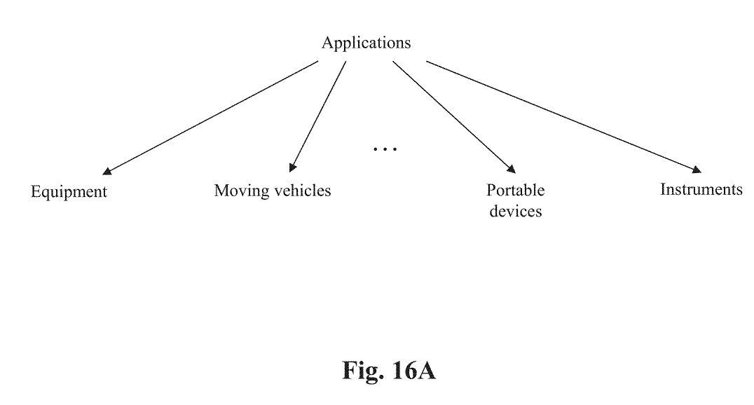

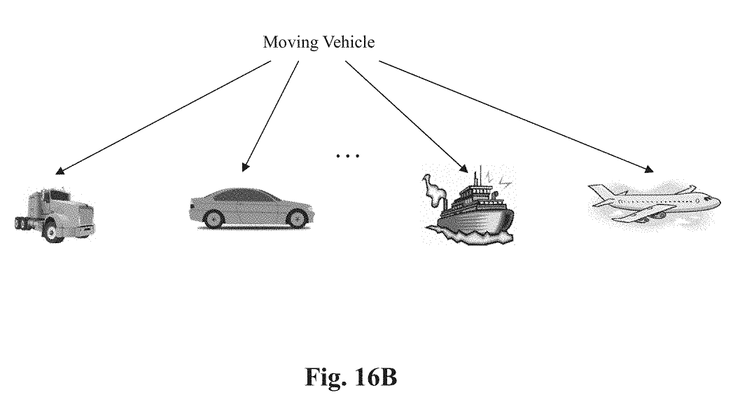

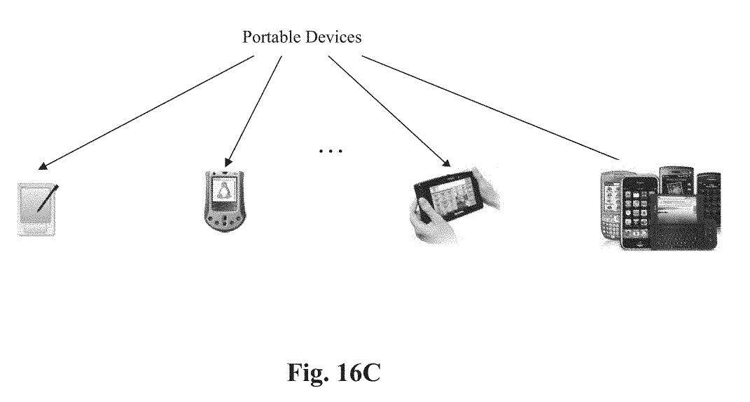

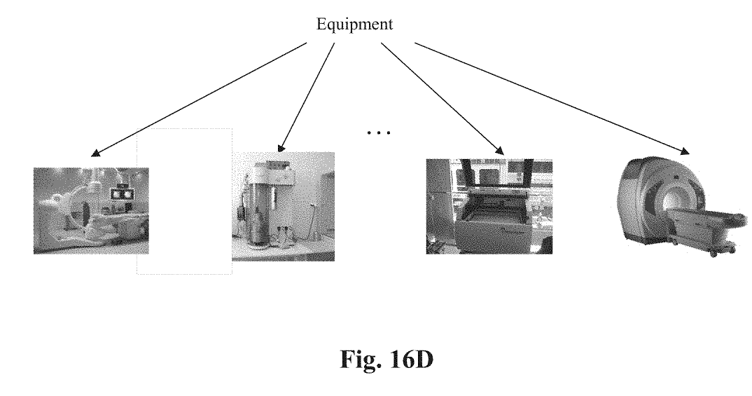

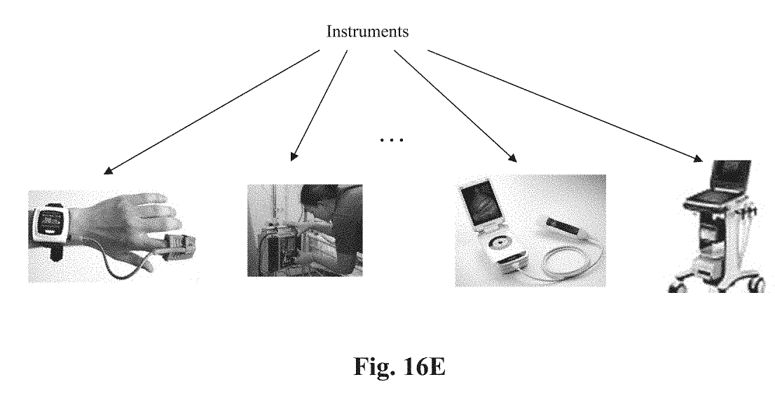

FIG. 15 depicts an exemplary framework 1500 which employs the disclosed battery modules/packs to enable automated and efficient battery services, according to an embodiment of the present teaching. The framework 1500 comprises various applications 1510 that employ the disclosed battery modules/packs, a distributed service center network 1540, a BSCCC (battery service central control center) 1530, and a network 1520 via which different parties may be connected. In this framework 1500, the applications 1510 include a variety of applications that employ batteries and may require services. This include moving vehicles 1510-b, boats/ships 1510-a, . . . , computers 1510-c, . . . , instruments 1510-d, . . . or equipment (now shown). This is also illustrated in FIG. 16A, which shows that applications of batteries include, but not limited to, equipment, moving vehicles, . . . , portable devices, . . . , and instruments. FIG. 16B provides exemplary types of applications in the category of moving vehicles, including but not limited to, shipping trucks, automobiles, . . . , boats, and airplanes. FIG. 16C provides exemplary types of portable devices that may employ batteries, including but not limited to, personal data assistant (PDAs), gaming device, mobile devices (phones, tablets, laptops), and other special purpose devices such as Kindles, etc. FIG. 16D provides example equipment, including but not limited to, medical equipment, lab research equipment, office equipment, . . . , and industrial equipment. FIG. 16E further provides exemplary types of instruments, including but not limited to medical instruments, lab research instruments, testing instruments, emergency test instruments, etc.

The service center network 1540 may comprise many distributed service centers, including service center 1 1540-a, service center 2 1540-b, . . . , service center n 1540-c. Such service centers may be distributed geographically and equipped with service stations/tracks which may be automatically configured or assigned to deliver requested services. A service center may also be equipped with robot arms that can be dynamically configured in accordance with, e.g., types of services to be provided (e.g., replace a low power battery), specific tasks to be performed to deliver the service (e.g., detach the battery, take it out, move in the replacement battery, and attach the new battery), and/or the pose of the battery module/pack to be replaced (e.g., what angles the robot arm needs to be in order unscrew various terminals of the battery). Each robot arm may be suitable for perform a certain group of tasks.

A battery pack in such an application may send a service request via the network 1520 to either BSCCC 1530 or to any of the service centers that the battery pack selects. If the service request is sent to the BSCCC 1530, the BSCCC 1530 may be configured to select one or more service centers based on, e.g., the geo position of the battery pack requesting the service and/or the type of service requested. The service request is then forwarded to the selected service centers. The service centers that receive the service request may respond either to the BSCCC 1530 or directly to the battery pack requesting the service or to both as to whether it can handle the service.

When the response is sent to the BSCCC 1530, upon receiving the response, the BSCCC 1530 may analyze the response and if the response indicates that a service center cannot handle the requested service, the BSCCC 1530 may make other selection of a service center. This process may repeat until a service center responds with a confirmation. This may be a similar process as for the PSMC 240, as disclosed with reference to FIG. 10A. Each PSMC 240 identifies a service center for its needed service may correspond to a distributed approach and in this distributed approach, each PSMC 240 may need to be equipped with service center distribution maps (e.g., service center maps 1025 in FIG. 10A), which may need to be updated from time to time for all PSMCs. This may be done after a battery pack is replaced and maintained at a service center and the service center maps may be updated before the battery pack is re-deployed.

Depending on the location of the service center where the service center maps are updated, different service center maps may be uploaded to the PSMC of the battery pack when it is re-deployed, depending on the application for the re-deployment. For example, if a battery pack is re-deployed in equipment fixed at a location which requires battery service to be delivered at the location (house service), the updated service center maps may include only those corresponding to the service centers nearby the location of the equipment. On the other hand, if the batter pack is re-deployed in a moving vehicle, the updated service center maps may include service center maps covering a much larger region (e.g., the entire country) in order to be effective. As another example, if the battery pack is to be re-deployed in an instrument such as a mobile phone or any other hand held device, the updated service center maps to be initialized for the PSMC of the battery pack may cover an even larger region (e.g., all countries) in case that the application (mobile phone or any other hand held device) may be taken to any country and require service during that period.

Having a centralized BSCCC 1530 to identify appropriate service centers for service requests from different PSMCs corresponds to a centralized approach. The BSCCC 1530 itself may be a distributed system, e.g., having different regional BSCCCs covering different geographical regions. In this centralized embodiment, it may be adequate for the BSCCC 1530 to maintain updated service center maps without having to update the service center maps on each PSMC when it is deployed (or re-deployed). In some embodiments, a mixed approach may be employed. That is, some battery packs may be equipped with PSMCs having service center maps 1025 embedded therein so that they are capable of identifying service centers on their own to meet their service needs. In this mixed approach, there are also some battery packs with PSMCs that are not come with embedded service center maps and rely on BSCCC to locate appropriate service centers when needed.

In any of the above approaches (distributed, centralized, and mixed), the BSCCC 1530 may be informed of any update on occurred battery services, e.g., what service is delivered by which service center to which battery pack/module, the details of the service (type of service, date/time of the service, etc.), the status of the battery pack/module at the time being serviced, the status of the replacement battery pack/module at the time of the deployment, etc. Such information may be used for different purposes. For example, a centralized record of services may facilitate centralized billing or payment, although individual service centers may be configured with the ability of billing and collecting payment for the services rendered at the service centers. As disclosed herein, each battery module/pack is identified via uniquely recognizable identifiers (e.g., BMIDs and PMIDs), which allow a centralized battery management system such as the BSCCC 1530.

At BSCCC 1530, there may be some human operators 1550 who, when needed, can communicate with a user of an application for any issues that need to be resolved in providing battery related services. For instance, a user of a moving vehicle may call the BSCCC 1530 for a needed service when the power of the battery deployed in the moving vehicle is completely wiped out so that the PSMC in the battery pack is not able to contact any service center. Such a human operator may also be provided at a service center (now shown) so that the user may also call directly to a local service center for, e.g., house service to the battery. A service center may also be configured to provide drive through services with each window having a human service provider to replace batteries for, e.g., applications that are difficult for a robot arm to handle or when robots are not available. As another example, for any billing related issues, users of applications employing battery modules/packs may also call either the BSCCC 1530 or individual service centers to talk a human operator.

With respect to service centers, there may be different types of service centers, each may be configured to provide different specialized services. For example, for moving vehicles, service centers for serving the battery needs of moving vehicles may be specially configured to provide efficient battery services to battery modules/packs deployed in moving vehicles. There may be other types of service centers, e.g., devoted to services to other types of applications. For example, some service centers may be constructed to provide drive through services for, e.g., small devices which usually takes only a few minutes to replace a battery in such devices. As another example, some service centers may specialize house services and such a service center may serve as a scheduling office and all services are performed by mobile service truck delivering services to where the batteries are located.

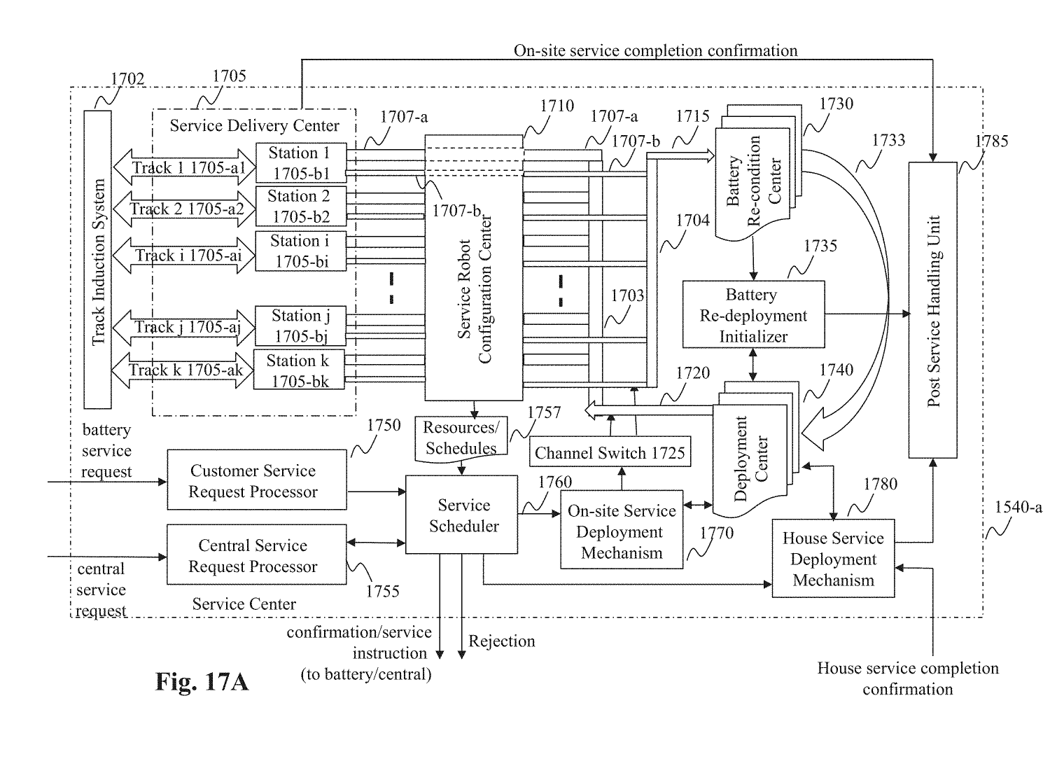

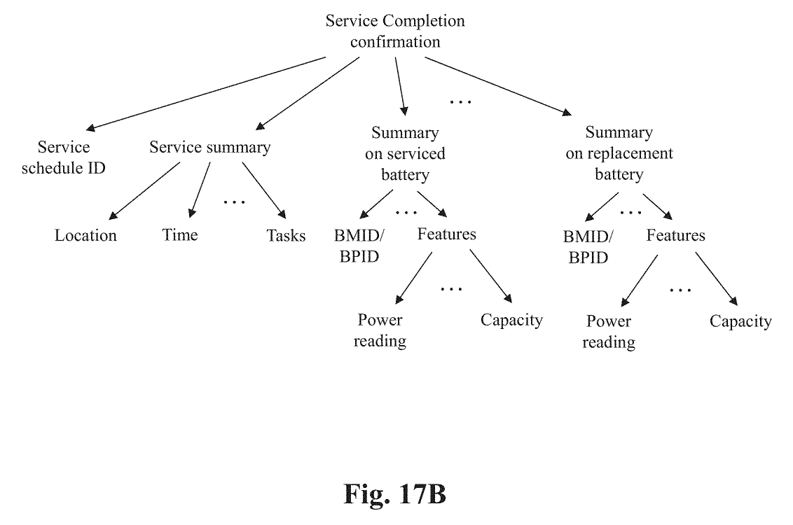

FIG. 17A depicts an exemplary construct of a service center 1540-a for providing battery services, according to an embodiment of the present teaching. In this illustrated embodiment, the service center 1540-a comprises several parts, including a part for processing a service request, a part for scheduling the requested service, a part for configuring resources for delivering the requested service, a part for service delivery, a part for post service processing, and a part for battery maintenance/re-deployment. Specifically, in this embodiment, the part of processing a service request in the service center 1540-a includes a customer service request processor 1750, a central service request processor 1755, which are configured to process a service request from a battery pack or from the BSCCC 1530, respectively.

A battery service request sent by a battery pack is received by the customer service request processor 1750 and processed. The customer service request processor 1750 then activates the service scheduler 1760 to schedule the requested service, which can be either an on-site service request or a house service. A centralized service request is received, by the central service request processor 1755, from the BSCCC 1530. Upon analyzing the central request, the central service request processor 1755 sends the central service request to the service scheduler 1760 to schedule the requested service, which can be on-site or house service.

The part of scheduling a requested service in service center 1540-a, whether an on-site or house service, comprises a service scheduler 1760, an on-site service deployment mechanism 1770, and a house service deployment mechanism 1780. Upon activated by either the customer service request processor 1750 or the central service request processor 1755, the service scheduler 1760 processes the service request received. To determine whether the service center 1540-a is able to handle the service request, the service scheduler 1760 accesses the resources/schedules archive 1757 which may record the scheduled services and the available resources for additional services. The available resources archived may include different types of resources, including but not limited to, a list of available tracks/stations where on-site service can be rendered, robot arms that can be deployed at different tracks/stations for delivering services, the time slots for the availability of each of the tracks/stations and robots, batteries that have been re-conditioned and can be deployed in services, mobile service trucks and their corresponding availability time slots, human resources that can be deployed at either on-site or house service locale, etc.

Based on the available resources and the requested service, the service scheduler 1760 then may determine whether the service center can handle the service request. There are different conditions under which the service center may not be able to handle. For example, if the service requested requires to be delivered in such a time frame during which the service center has already fully committed to other services. Alternatively, if the special robot arm required to deliver the requested service is not available, the service center also cannot schedule the requested service. As another example, if a needed battery will not be fully charged in the time frame of the requested service, it may also cause the service scheduler 1760 to determine that the service center will not be able to schedule the service request. When it is determined that the service request cannot be scheduled at the service center 1540-a, the service scheduler generation a rejection message and send to the party who initially sent the service request (either a battery pack or the BSCCC 1530).

If the service scheduler 1760 determines that the requested service can be scheduled, it generates a schedule with the available resources at the service center 1540-a within the time frame of the requested service. Upon generating the service schedule, the service scheduler 1760 updates that service schedule 1757 to reflect the fact that certain resources have been scheduled to deliver the current requested service and are no longer available for certain time slots. Depending on whether the requested service is for on-site or house delivery, the service scheduler 1760 sends the service schedule to appropriate deployment mechanism to effectuate the service delivery. Specifically, for a scheduled on-site service, the service scheduler 1760 activates the on-site service deployment mechanism 1770; while for a scheduled house, the service scheduler 1760 activates the house service deployment mechanism 1780. To prepare for providing an on-site service, the on-site service deployment mechanism 1770 may need to activate the part of the service center 1540-a to generate the scheduled configuration for deliver the scheduled service. On the other hand, to effectuate the scheduled house service, the house service deployment mechanism 1780 may communicate with, e.g., a mobile service truck scheduled to deliver the service to effectuate the requested service.

The service center 1540-a also includes a part for configuring the resources needed to deliver the scheduled service. This part comprises a channel switch 1725, various channels, e.g., 1707-a and 1707-b (and other similar channels), conduits 1703 and 1704, as well as a service robot configuration center 1710. Resources include, but not limited to, batteries to be deployed to fulfill the request and/or robot arms configured to operate to, e.g., detach a problem battery from a moving vehicle and install a replacement battery back. Depending on which station is scheduled to be used to deliver the service, different channels need to be switched to form a path to transfer resources needed to the station where the service is delivered. This is achieved by the channel switch 1725, which takes an input from the on-site service deployment mechanism 1770 and accordingly switches or configures the channels appropriately so that scheduled resources needed for the service are transferred, via a path configured by connecting such configured channels, to a scheduled station. For example, if a service is scheduled to be performed at station 1 1705-b1, channels 1707-a is switched, by the channel switch 1725, to connect to conduit 1703 so that a battery to be used for the service can be delivered from a deployment center 1740 (where all the batteries that can be deployed are stored) to station 1.

Similarly, to allow a replaced battery to be transferred out of a station after the service, the channels are configured in such a manner to form a path between a station and a battery re-condition center 1730 where the replaced battery is to be re-conditioned. This is also achieved by the channel switch 1725. For instance, if the service is scheduled at station 1 1705-b 1, channel 1707-b is switched to connect to conduit 1704 so that a replaced battery can be transferred from station 1 to the battery re-condition center 1730.

In addition to configured the paths to transfer batteries, the service robot configuration center 1710 may configure robots or robot arms according to a service schedule, which may provide information about which battery module in a battery pack needs to be replaced and the pose of the battery module (such information is provided in the service request received). With such information, a robot or robot arm may be configured in such a way that, when deployed at a scheduled station for service, the configured robot or robot arm can efficiently accomplish the operations called for by the requested service. For instance, if the requested service is to replace a low power battery pack in a moving vehicle, a robot may be configured to perform a series of tasks, e.g., identify the battery pack, find the terminals that need to be unscrewed, unscrewed the terminals, extract the battery, remove the battery, locate the replacement battery, position/orient the replacement battery properly, place the replacement battery in place, screw the terminals to install the replacement battery, test the replacement battery, close the hood of the moving vehicle, and send a signal indicating completion of the service.

Configuration of a robot or robot arm may be performed in accordance with various types of information, some received via the service request and some received from the service schedule generated by the service scheduler 1760. Examples of such information include, but not limited to, the station at which the service is to be delivered (so that it can be determined which robot or robot arm to be configured), the maker and model of the vehicle (so that the position and orientation of the battery is known), the type of battery that needs to be replaced (so that it can be determined how to uninstall it), the specific replacement battery to be deployed (so that it can be determined how to install the replacement battery).

The configuration may also include a time of service so that a robot can be deployed within the scheduled time frame. Each station may have a series of services to be performed and each service may deploy a different robot so that each robot scheduled for deliver a service at a scheduled time may be configured with a job ID that is associated with a time frame for the scheduled service. The configuration of a robot may also include switching (inside the service robot configuration center) a robot to the correct channel for the service the robot is configured to perform. The robots switched to the same channel may also be sequenced according to order of the services each is to perform. In this manner, a plurality of robots dispatched to the same channel (corresponding to the same station these robots will deliver services in a sequence) wait in a queue to be deployed to the station in turn.

As disclosed herein, the service center 1540-a also includes a part for delivering the requested service. In the exemplary embodiment depicted in FIG. 17A, this part of the service center comprises a track induction system 1702 and a service delivery center 1705. The service delivery center 1705 includes a plurality of the service delivery tracks, namely track 1 1705-a1, track 2 1705-a2, . . . , track i 17-5-ai, . . . , track j 1705-aj, . . . , and track k 1705-ak, and their corresponding service delivery stations, namely station 1 1705-b1, station 2 1705-b2, station i 1705-bi, . . . , station j 1705-bj, . . . , and station k 1705-bk. As shown, in this embodiment, each track leads to a service station. However, other configurations are also possible. For example, multiple tracks may lead to the same station or vice versa, i.e., each track may lead to multiple stations.

The track induction system 1702 may be optionally provided, which may be provided to improve the management of the service volume. As disclosed herein, in this embodiment, when a service center sends a service instruction, it may provide therewith an induction, which can be used when entering the service center to be automatically guided to the correct track/station via the track induction system 1702. In some embodiments, the implementation can be that each track has a gate and when the induction number matches with the security code of the gate for a particular track, the gate will automatically open to allow entry. Other implementation may also be possible. Once the track induction system 1702 detects the arrival of the battery pack with the correct induction ID, the track induction system 1702 may also inform, via network connection within the service center (wireless or wired), the station that the service is to be delivered soon so that all resources needed to provide the requested service are to be put in place at the scheduled station to deliver the service.

In this embodiment, each station may be connected to not only a track but also two channels, one for moving into the station the resources needed for the requested service and one for moving out the resources and the replaced battery module/pack out of the station. For example, associated with station 1 1705-b 1, there are two channels, one being 1707-a and one being 1707-b, as shown in FIG. 17A. In some embodiments, channel 1707-a may be designated as the channel to move resources (e.g., robot arms or replacement battery) into the station 1 1705-b1 and channel 1707-b may be designated as the channel to move resources (e.g., robot arms or replaced battery) out of station 1 1705-b 1. The channels 1707-a and 1707-b may go through a service robot configuration center 1710. The channel 1707-a is connected to a deployment center 1740 where various re-conditioned batteries are stored and deployed so that a re-conditioned battery scheduled to be used to replace a problematic battery can be placed on channel 1707-a and moved to station 1. Channel 1707-b is instead connected to a battery re-condition center 1730 where all replaced batteries are re-conditioned (e.g., charged, repaired, or removed from service). Via channel 1707-b, a replaced battery can be moved out from station 1 and transferred to the battery re-condition center 1730.

The part of service center 1540-a for battery maintenance/deployment thus comprises the battery re-condition center 1730, the deployment center 1740, and a battery re-deployment initializer 1735. When a replaced battery is removed from its application, it is transferred to the battery re-condition center 1730, e.g., from station 1 to channel 1707-b and to the battery re-condition center 1730. At the battery re-condition center 1730, there may be different sub-parts (now shown), some of which may be for charging and some of which may be for repair. Depending on the problems reported about the replaced battery, the replaced battery may, upon being transferred to the battery re-condition center 1730, be automatically moved to the appropriate sub-part or even automatically placed on designated shelf space for the needed re-conditioning. For instance, a replaced battery that needs charging may be transferred, e.g., via a conveyance belt or other transport mechanism, to an empty spot on a charging rack. All these can be automated based on the status information about the battery, either received from the battery or generated by a station when the battery is being replaced at the station. In this manner, maintenance of batteries can be centralized at a service center, making it much more efficient.

When a battery is re-conditioned, e.g., charged or repaired, the battery re-condition center 1730 informs the battery re-deployment initializer 1735. Such initialization may include inserting various re-conditioned parameters, e.g., power level or capacity, date/time of the completion of maintenance, etc. into the module blackbox of each module. Each re-conditioned battery, upon being initialized, may be transferred, via transfer path 1733, to the deployment center 1740 for re-deployment or put back into service. The deployment center 1740 may maintain a list of all batteries that are ready to be re-deployed, each with their corresponding information such as the current condition they are in, e.g., the power level. Information related to re-conditioned batteries may also be transmitted to the resource schedule 1757 (not shown) so that such available batteries can be scheduled for the re-deployment.

When a re-conditioned battery is scheduled to be re-deployed, the deployment center 1740 may also re-set certain parameters of the re-conditioned battery. For example, the usage configuration of the battery may be re-set based on, e.g., parameters of the application in which the battery is about to be deployed. Examples of such parameters include, e.g., whether the application is an instrument or a moving vehicle, the battery requirement of the application (e.g., minimum power level), the specific communication protocol to be used to communicate with the application, etc. Once the usage configuration is initialized, the battery, once deployed, will use the information stored therein to determine how to operate in different situations. In addition, the blackbox(es) in the battery may also be updated with, e.g., the re-conditioned status information.

A re-deployed battery, once scheduled, may be transferred from the deployment center 1740 to the scheduled station via a channel connecting the deployment center 1740 and the scheduled station for delivering the service. For instance, if the scheduled station is station 1 1705-b 1, channel 1707-a is to be used to transfer a battery to be deployed to station 1. As discussed herein, the channel switch 1725, upon receiving a deployment instruction from the on-site service deployment mechanism 1770, switches channel 1707-a to be connected to a first conduit 1703 which is connected to an outlet channel 1720 of the deployment center 1740. Via this switch, when the deployment center 1740 places the battery scheduled to be deployed on the outlet channel 1720, the battery is transferred to the channel 1707-a, via the first conduit 1703.

Similarly, the channel switch 1725 may also switch channel 1707-b to be connected to a second conduit 1704 so that when the service is delivered at, e.g., station 1, the replaced battery is transferred from station 1 to channel 1707-b and to the battery re-condition center 1730 via the second conduit 1704.

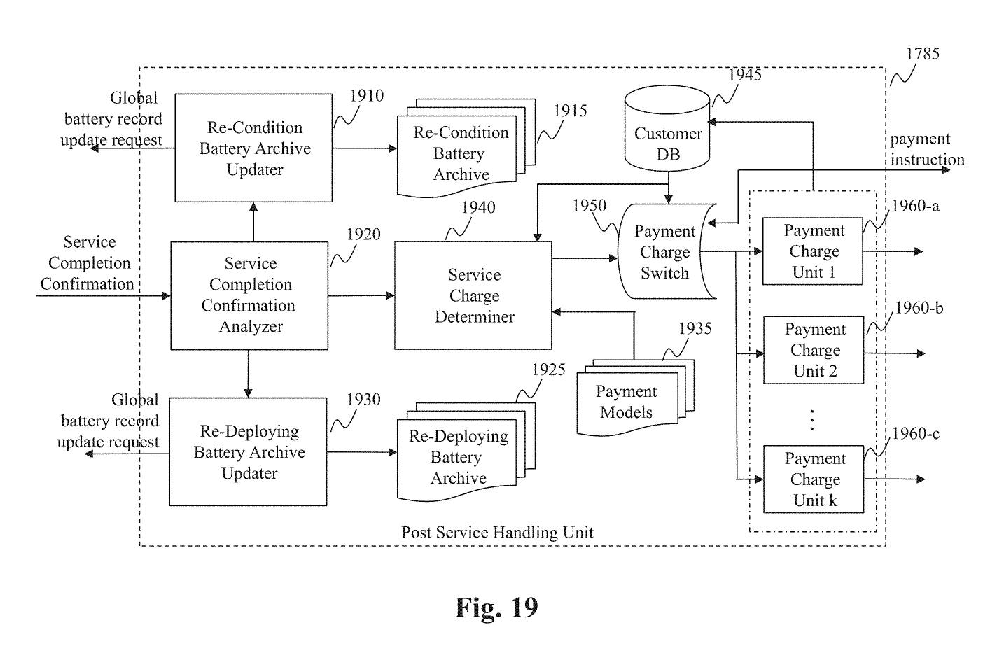

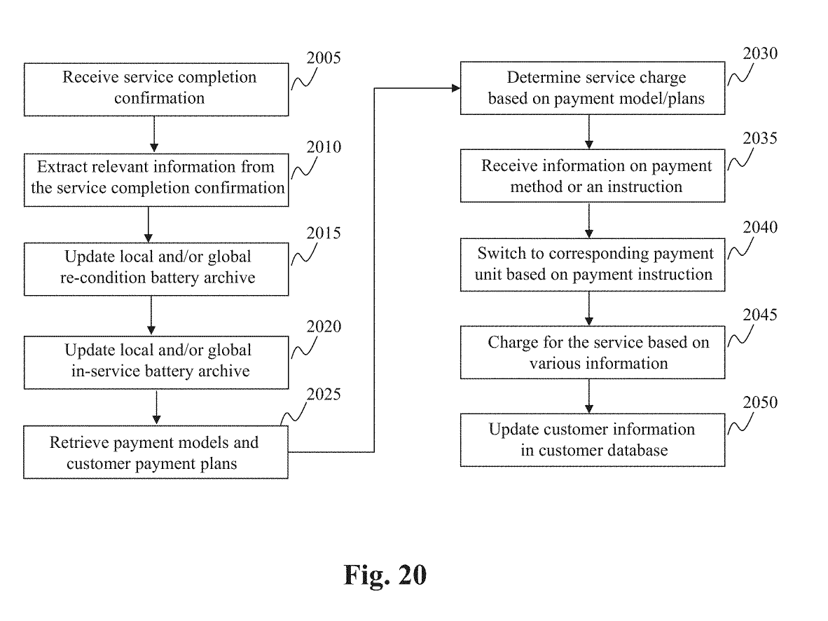

The service center 1540-a also has a part for post service processing, which is performed by a post processing handling unit 1785. The post service handling unit 1785 is invoked when it receives a service completion confirmation. When an on-site service is completed, the station that just delivered the scheduled service in the service delivery center 1705 may send an on-site service completion to the post service handling unit 1785. When the scheduled house service is completed (which is initiated by the house service deployment mechanism 1780), the service team that delivered the house service may send a house service completion confirmation to the house service deployment mechanism 1780, which then forwards the house service completion confirmation to the post service handling unit 1785. Details of the post service handling unit are provided in reference to FIGS. 19-20.

In operation, when the service center 1540-a receives a service request (from either an application or from the BSCCC 1530), the service scheduler 1760 determines whether the service request can be handled at the service center. If it is determined that the service center cannot schedule the requested service, the service request is rejected. Otherwise, the service scheduler 1760 generates a service schedule and sends to the corresponding deployment mechanism (on-site service deployment mechanism 1770 for on-site service and to house service deployment mechanism 1780 for house service). The service schedule is also used to update the record in the resources/schedules archive 1757 so that the current service schedule is made known. Upon receiving the service schedule, the house service deployment center 1780 then send the service schedule to the scheduled service team to carry out the service. The service team sends, upon completion of the service, a house service completion confirmation to the house service deployment mechanism 1780. When receiving the house service completion confirmation, the house service deployment mechanism 1780 sends the service schedule and the house service completion confirmation to the post service handling unit 1785 for post service processing.

For an on-site service, the service scheduler 1760 invokes the on-site service deployment mechanism 1770 with the service schedule. To effectuate an on-site service, the on-site service deployment mechanism 1770 sends the service schedule to the channel switch 1725, the deployment center 1740, and the service robot configuration center 1710 (connection now shown). The channel switch 1725 may then switch, based on the service schedule (e.g., the service will be delivered at which station in the service delivery center 1705), appropriate channels to be connected with certain conduits to form needed paths to transfer needed resources for the service in and out of the station where the scheduled service is to be delivered. For example, if the service is to be delivered at station 1, channels 1707-a and 1707-b are switched to be connected to conduit 1703 and 1704, respectively.

The on-site service deployment mechanism 1760 also invokes the deployment center 1740 with the service schedule to provide the replacement battery scheduled for the service. Upon being activated, the deployment center 1740 proceeds to locate the replacement battery, e.g., specified in the service schedule. The identified replacement battery may be processed to re-populate necessary information in the replacement battery, such as the usage configuration, based on the information provided in the service schedule, e.g., the application in which the replacement battery is to be deployed (e.g., with the service request). The deployment center 1740 may then place the processed replacement battery in its outlet channel 1720, which is connected to the conduit 1703. As the conduit 1703 is now connected to an appropriately switched channel to form a path leading up to the station where the service is to be delivered, the replacement battery can be transferred to the service robot configuration center 1710 and ultimately to the scheduled station. For example, if the scheduled service station is station 1, channel 1707-a is switched to connect to the conduit 1703 so that a replacement battery out of the deployment center 1740 in the outlet channel 1720 can be transferred via conduit 1703 and channel 1707-a to the service robot configuration center 1710 and ultimately to station 1, as shown in FIG. 17A.

On the other hand, the service robot configuration center 1710 proceeds, upon receiving the service schedule, to locate the robot or robot arm scheduled to deliver the service and to configure the robot or robot arm in accordance with the information in the service schedule (e.g., received from the service request) on, e.g., the specific pack/module to be replaced and/or its pose as well as the time frame of the scheduled service. The replacement battery from the deployment center 1740 may be transferred to where the configured robot is in the service robot configuration center 1710 so that both can be further pushed to the station to deliver the service when it is close to the schedule service time.

When the service is completed at the scheduled station, the robot is configured to place the replaced battery on the designated channel to transfer out the resources out of the station. For example, if the service station is station 1, the channel to transfer resources out of station 1 is channel is 1707-b, which has been switched to be connected to conduit 1704. Via channel 1707-b, the robot that delivered the service is transferred back to the service robot configuration center 1710. The service robot configuration center 1710 then may update the resources/schedules archive 1757 so that the robot just returned to the service robot configuration center 1710 will become an available resource. As to the replaced battery, along the path formed by channel 1707-b and conduit 1704, the replaced battery can be transferred via the path to the intake channel 1715 of the battery re-condition center 1730 so that the replaced battery is now taken in for re-conditioning. On the other hand, when the on-site service is completed at a service station (possible when or after the resources transferred out of the service station), the service station sends an on-site service completion confirmation to the post service handling unit 1785.

FIG. 17B illustrates an exemplary service completion confirmation, according to an embodiment of the present teaching. Such a service completion confirmation signal may correspond to a house service or from an on-site service, which may be, e.g., identified from the information contained therein, which is illustrated in this exemplary embodiment. Other ways to distinguish from an on-site and house service may also be adopted. For example, as shown in FIG. 17B, a service completion confirmation may comprise a service schedule ID which may be used to associate with the corresponding service schedule, a summary of the service performed, a summary on the serviced battery (or replaced battery if replacement occurred), a summary on the replacement battery if any, etc.

The summary for the service performed may provide information on the location of the service, the date/time of the service rendered, . . . , and the specific tasks performed (e.g., replaced a low power battery and installed a fully charged battery). The summary on the serviced battery may include an identifier (e.g., battery module identifier BMID or battery pack identifier BPID) of the battery serviced (or replaced) and various other related information including, but not limited to, the power level, . . . , and the capacity reading of the services batter at the time of the service. The summary of the battery used to deliver the service (e.g., replacement battery) may include also an identifier (e.g., battery module identifier BMID or battery pack identifier BPID) and various other related information about the battery, including but not limited to, the power level, . . . , and the capacity reading at the time of the service. The power levels and/or the capacity readings from the respective serviced battery and the replacement battery may be used, by the post service handling unit 1785 as disclosed below, to determine a service charge in association with the service delivered. This is

After the replaced battery is transferred back to the battery re-condition center 1730, it is re-conditioned until it reaches a status for re-deployment. When that occurs, the battery re-deployment initializer 1735 re-initializes the battery and the battery is then transferred to the deployment center 1740 via conduit 1733 so that it is now wait for being re-deployed. When receiving a newly re-conditioned battery, the deployment center 1740 updates the record in the resources/schedules archive 1757 so that the re-conditioned battery is an available resource and can be scheduled for the next deployment.

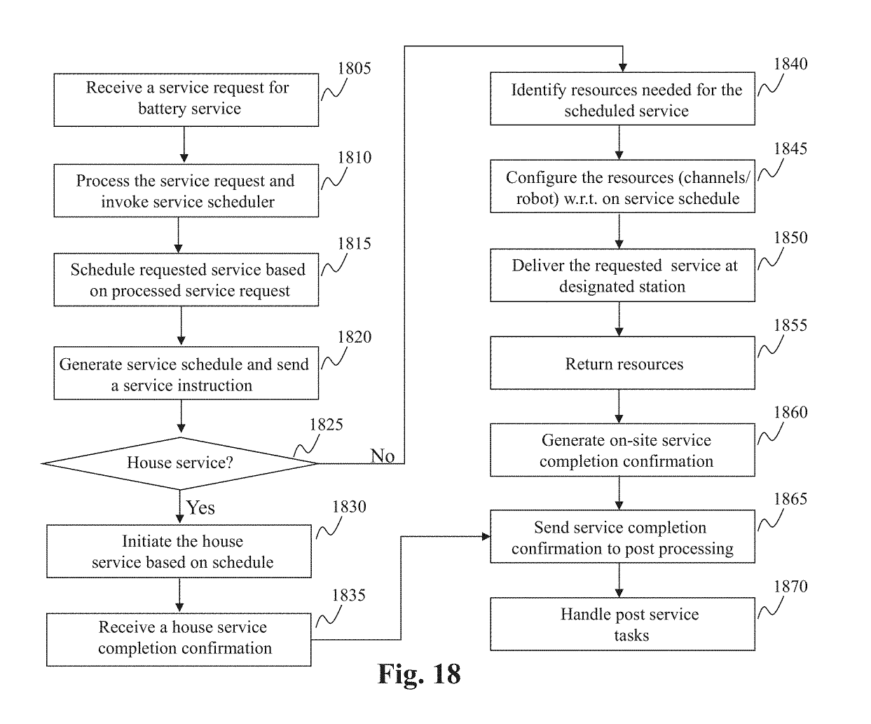

FIG. 18 is a flowchart of an exemplary process of a service center, according to an embodiment of the present teaching. In this exemplary flow, the service center receives, at 1805, a service request from a battery or the BSCCC 1530 requesting a battery service. The service request is processed at 1810 and the service scheduler 1760 is activated to schedule, at 1815, the requested service. If the requested service is house service, determined at 1825, the process proceeds to initiate, at 1830, the scheduled house service. When the house-service deployment mechanism 1780 receives, at 1835, a house service completion confirmation, it sends, at 1865, the received service confirmation to the post service handling unit 1785.

When the scheduled service is on-site, determined at 1825, the process proceeds to identify, at 1840, and configure, at 1845, the resources needed for the service. The scheduled service is delivered, at 1850, at a designated station. After the service is completed, resources used for the delivery are returned, at 1855, to appropriate places. This may include, but not limited to, returning the replaced battery to the battery re-condition center 1730, placing the robot that just delivered the service to the service robot configuration center 1710, unswitching the channels, etc. In addition, an on-site service completion confirmation is generated at 1860, by, e.g., the service delivery center 1705, which is then sent, at 1865, to the post service handling unit 1785.

The post service handling unit 1785, upon receiving the service completion confirmation (from either the house service deployment mechanism 1780 or from a service station), proceeds to perform, at 1870, a variety of tasks, including but not limited to, computing the service charge for the service just delivered and invoicing the user who is responsible for the service charge.

FIG. 19 depicts an exemplary system diagram of the post service handling unit 1785, according to an embodiment of the present teaching. In this exemplary embodiment, the post service handling unit 1785 comprises a service completion confirmation analyzer 1920, a service charge determiner 1940, a payment charge switch 1950, and various payment charge units, including payment charge unit 1 1960-1, payment charge unit 2 1960-2, . . . , and payment charge unit k 1960-k. Optionally, the post service handing unit 1785 may also be designed to keep and update the records of the batteries that came and left the service center, e.g., via an archive 1915 of those batteries being re-conditioned (the batteries that came to the service center) and an archive 1925 of those batteries that are re-deployed from the service center (the batteries that left the service center). To keep such records up to date, the post service handling unit 1785 may also include a re-condition battery archive updater 1910 and an in-service battery archive updater 1930.

In operation, the service completion confirmation analyzer 1920 receives a service completion confirmation (either from the house service deployment mechanism 1780 or from a station in the service delivery center 1705). The service completion confirmation is analyzed and different types of information may be extracted from the completion confirmation, e.g., service performed, the replaced battery ID and its readings at the time of replacement, the replacement battery ID and its readings at the time of the deployment, etc.). Such extracted information is used by the service completion confirmation analyzer 1920 to activate other processing units. For example, if the service involves a replaced battery, the re-condition battery archive updater 1910 is invoked with the BMID/BPID of the replaced battery. On the other hand, if a replacement battery is used to replace a problematic battery, the in-service battery archive updater 1930 is invoked with the BMID/BPID of the replacement battery. With the extracted information on type of service performed, the service charge determiner 1940 is invoked to compute the service charge for the delivered service.

The re-condition battery archive updater 1910, upon being invoked, updates the record in the re-condition battery archive 1915 based on the BMID/BPID of the replaced battery and this is an update performed on the local record at the service center. The update may also be extended to a global record of all batteries in the, e.g., marketplace. Such as global record update may be carried out elsewhere, e.g., at the BSCCC 1530, and the re-condition battery archive updater 1910 may send a request for the global record update.

The in-service battery archive updater 1930, upon being invoked, updates the record in the in-service battery archive 1925 based on the BMID/BPID of the replacement battery and this is an update performed on the local record at the service center. The update may also be extended to a global record of all batteries on their status, e.g., re-condition, in-service, etc. Such as global record update may be carried out elsewhere, e.g., at the BSCCC 1530, and the in-service battery archive updater 1930 may send a request for the global record update.

The service charge determiner 1940 may, when invoked, compute the service charge based on, e.g., the service provided, the way to deliver the service (e.g., on-site or house service), the unit price of the service, the estimated value of the service, and any other terms that need to be complied with between the service center and the customer. The service center may have certain charging table for the services rendered based on which service unit price may be determined. This is stored in an archive for payment models 1935. Such models may change over time and have fluctuated unit prices for different service items. For a customer corresponding to the completed service, the service charge determiner 1940 may access information or payment preference of the customer from a customer database 1945, which may store information of different customers, including their corresponding charging terms, discount rates or coupons as applied to each. Such information may be dynamically updated, e.g., the coupons may have dynamic values computed based on the frequency of services, etc. Such information may also be considered in determining the service charge to the customer.

To compute a service charge, the value of the service may also be considered. Some service may provide higher value than others and the higher the value of service provided, the higher the service charge. For example, replacing more than one module in a battery pack may provide a higher value than replacing only one module in the pack. In addition, replacing a battery module in a pack that has a lower level of power/capacity with a fully charged replacement battery in its full capacity may provide a higher value to a customer than replacing a battery module that has a higher level of remaining power/capacity with the same replacement battery. As another example, replacing a battery with a replacement battery that has a higher power density may provide higher value than replacing the battery with a replacement battery at the same power density. To determine the value of the service, the service charge determiner 1940 analyze different readings, e.g., the power, the capacity, and/or the power density, from both the replaced and replacement battery modules/packs. The service charge determiner 1940 may also access appropriate payment models in 1935 according to the specific situation in hand and compute the service charge.

With the service charge determined, the service charge determiner 1940 may then activate the payment charge switch 1950, which may then access information stored in the customer database 1945 to, e.g., determine payment preferences. For example, some customers may prefer monthly billing, some may prefer credit automatic payment, some may prefer to pay through PayPal, some may use a pre-set mechanism for deduct the service charge from a pre-paid amount of fund stored in the pre-set mechanism. In some embodiments, a customer may not be an existing customer of the service center but was directed to the service center by the BSCCC 1530 or referred from a different service center. In this case, the payment charge switch 1950 may receive a payment instruction from the BSCCC 1530 or a different service center instructing the payment charge switch 1950 how to switch to a payment method in accordance with the preference of their customer.

Based on a determined preferred payment method, the payment charge switch 1950 switches on any of the payment charge units 1, . . . carry out the payment charge. When the payment is cleared, the payment charge unit responsible for the charge may update the customer record in the customer database 1945. In some embodiments, the payment charge switch 1950 may generate a payment instruction and send it, e.g., to the BSCCC 1530 when a centralized payment is preferred or to a different service center when appropriate.

FIG. 20 is a flowchart of an exemplary process of the post service handling unit 1785, according to an embodiment of the present teaching. When the post service handling unit 1785 receives, at 2005, a service completion confirmation, it extracts, at 2010, various types of information from the service completion confirmation. Based on the extracted information related to the replaced battery, the post service handling unit 1785 updates, at 2015, the re-condition battery archive 1915 and optionally may request for an update of the replaced battery record in a global archive. Based on the extracted information related to the replacement battery, the post service handling unit 1785 updates, at 2020, the in-service battery archive 1925 and optionally may request for an update of the replacement battery record in a global archive.

To determine the service charge, the post service handling unit 1785 retrieves, at 2025, appropriate payment models 1935 and information stored in the customer database 1945 related to the payment plans or different terms to be applied in computing the service charge to be paid by the customer. Based on the retrieved information, the service charge determiner 1940 determines, at 2030, the service charge that should be paid for the completed service. When the service charge determiner 1940 computes the service charge, the payment charge switch 1950 receives, at 2035, information on preferred payment method with respect to the customer. Such payment method information may be received from the customer database 1945 or from elsewhere such as BSCCC 1530 or another service center. The payment charge switch 1950 then switches, at 2040, to activate an appropriate payment charge unit. The payment charge unit that is switched on then makes a charge, at 2045, based on the computed service charge in the payment method preferred by the customer. The payment charge unit then updates, at 2050, the information of the customer stored in the customer database 1945.

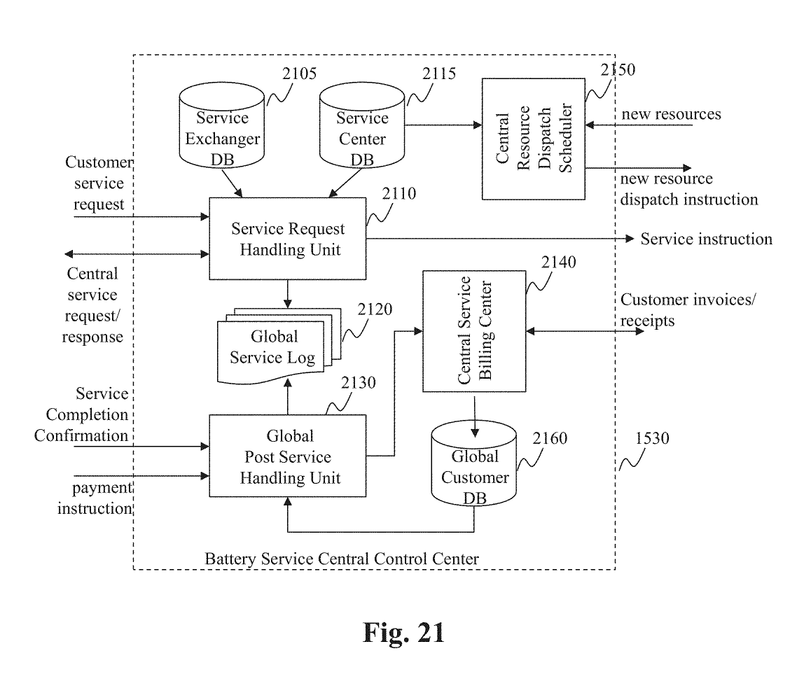

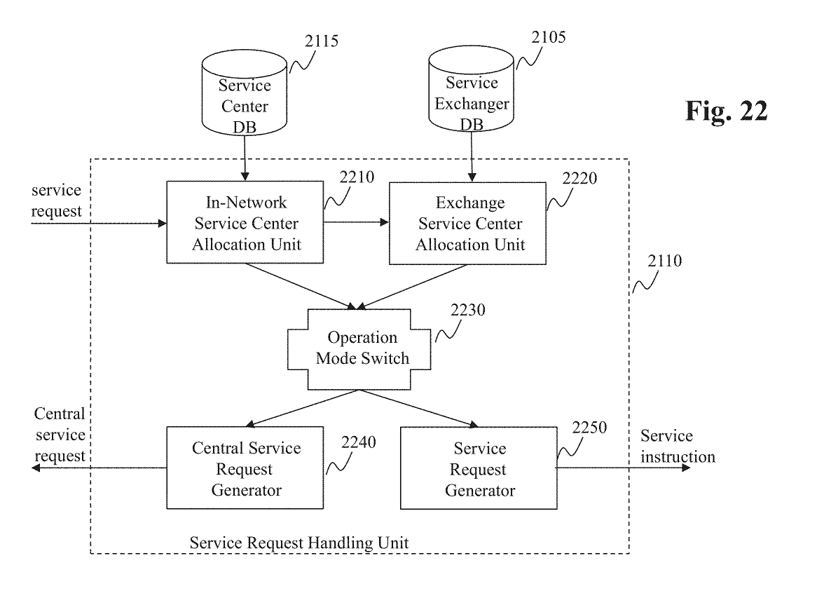

FIG. 21 depicts an exemplary system diagram of the BSCCC 1530, according to an embodiment of the present teaching. In this embodiment, the BSCCC 1530 comprises a service request handling unit 2110, a central resource dispatch scheduler 2150, a global post service handling unit 2130, and a central service billing center 2140. The service request handling unit 2110 is configured for processing a service request from a battery pack, selecting one or more service centers appropriate for the service request, communicating with the selected service centers to commit the service at a specific service center, and directing the service request or sending a service instruction to such a committed service center to facilitate the needed service. Details of the service requesting handling unit 2110 are discussed in FIG. 22.

The central resource dispatch scheduler 2150 is to automatically dispatch resources to different geographically distributed service centers. Such resources include batteries, robots, and/or robot arms. The central resource dispatch scheduler 2150 is connected to a service center database 2115, which may record various types of information for each service center, e.g., including the geographical location of the service center, types of services to be provided by the service center, the capacity of the service center, existing resources available at the service center, volume of business of the service center, local demographics of the service center, utilization of the resources such as the re-deployment rate of the batteries and the idle rate of the robots, etc. Whenever new resources are purchased, a dispatch decision may be determined by considering different types of information so that a certain objective can be maximized. For example, resources are distributed to different service centers in order to, e.g., achieve high utilization of such resources.

The global post service handling unit 2130 may be configured to function in a similar way as the post service handling unit 1785 of a particular service center (see FIG. 17A). The global post service handling unit 2130 may be invoked when post service issues are to be handled in a centralized manner even when the actual service is delivered at a local service center. The global post service handling unit 2130 may receive a service completion confirmation from a service center, and carry out different functions similar to what is implemented in a local post service handling unit 1785. The global post service handling unit 2130 may be structured in a similar way as that of the local post service handling unit 1785 except that the archives and databases included in the global post service handling unit 2130 may be global rather than local so that the global post service handling unit 2130 can function at a larger scale. The BSCCC 1530 also includes a central service billing center 2140, which may be configured to handle billings and collections in a centralized manner and update the global customer database 2160 based on the billings/collections.

FIG. 22 depicts an exemplary system diagram of the service request handling unit 2110, according to an embodiment of the present teaching. In this exemplary embodiment, the service request handling unit 2110 comprises an in-network service center allocation unit 2210, an exchange service center allocation unit 2220, an operation mode switch 2230, a central service request generator 2240, and a service request generator 2250. In some embodiments, service centers may be divided into in-network and out-of-network services centers with respect to each specific BSCCC. An in-network service center with respect to a particular BSCCC may be connected to the BSCCC in a more direct way or somewhat under the control of the BSCCC. An out-of-network service center with respect to the particular BSCCC may be one that is an in-network service center of a different BSCCC. A BSCCC may send a centralized service request to its in-network service centers asking for a confirmation of delivering the needed service. If no in-network service center is found, the BSCCC may seek an out-of-the-network service center but it may be required to go through an exchange via a different BSCCCs.

In the embodiment illustrated in FIG. 22, the service request handling unit 2110 accesses information in the service center database 2115 and the service exchange database 2105. The service center database 2115 stores information about, e.g., in-network service centers for the BSCCC 1530. As disclosed herein, a variety of information about each service center in the network of BSCCC 1530 may be stored in the service center database 2115. The service exchange database 2105 may be configured to store information about other exchange BSCCCs that the BSCCC 1530 may contact to reach to their in-network service centers (that are out-of-network service centers for BSCCC 1530).

The service center allocation unit 2210, upon receiving a service request, may check first the service center database 2115 to identify service center(s) appropriate for the service request. The appropriateness may be assessed based on different considerations, e.g., the geographical affinity between the geo position of the battery sending the service request and the location of a selected service center. The appropriateness may also consider whether the selected service center provides the type of service requested. The appropriateness may also be assessed based on, e.g., whether a club card the customer has covers the selected service center. An appropriate service center may also be identified based on its availability. When the BSCCC 1530 is central control of its service centers, it may have the updated information about the load of each service center as well as resources available at the moment at each service center.

If the service center allocation unit 2210 cannot find an appropriate in-network service center, it may be configured to activate the exchange service center allocation unit 2220 to identify an out-of-network service center by contacting a different BSCCC identified from the service exchange database 2105. The exchange service center allocation unit may then communicate with the identified BSCCC, which may then assist to locate a service center that is out-of-the network with respect to BSCCC 1530 yet appropriate for the received service request. So, the exchange service center allocation unit 2220 may yield a service center selected from a network outside of the BSCCC 1530. The selection of an out-of-the-network service center may also be used based on the appropriate criteria as discussed above.

Once a service centers are selected (more than one is possible in some embodiments), the service request handling unit 2110 may contact the selected service center to proceed with the requested service. This may be done by generating a service instruction and send directly to the selected service center to command the selected service center to schedule to deliver the requested service. Alternatively, the BSCCC 1530 may allow the selected service center to either accept or reject the service request. In this case, the service request handling unit 2110 may merely send a central service request to the selected service center. The operation mode switch 2230 in FIG. 22 is configured to perform a switch between two alternative modes of operation. Which operation mode is to be switched on for each service request may depend on the configuration of the selected service center. Some service centers may be configured to always accept the service requests from its BSCCCs. Some service centers may be configured to require that any service request from the BSCCC 1530 has to be confirmed first.

Depending on the configuration of the selected service center, the operation mode switch 2230 either activates the central service request generator 2240 or the service request generator 2250. The former is activated when the service request has to be accepted by the selected service center before the service center can schedule to deliver the requested service. The latter is activated when the BSCCC 1530 can directly send a service instruction to the selected service center to command it to schedule the requested service. So, the central service request generator 2340, once activated, generates a central service request to be sent to the selected service center. If the selected service center accepts the central service request, it may then send a confirmation to the battery requesting the service and then proceed to schedule the requested service. If the selected service center rejects the central service request, it either does not respond to the service request or send a rejection to the battery requesting the service. When the battery requesting the service does not receiving any confirmation of service, it may continue to send the service request until the service is confirmed. In this case, the service request handling unit 2110 may continue to process the service request until the service is confirmed.

The service request generator 2250 may be activated when the selected service center is one that may be configured to always accept a service request from the BSCCC 1530. In this case, the service request generator 2250 can directly generate a confirmation of service with a service instruction to the battery requesting the service.

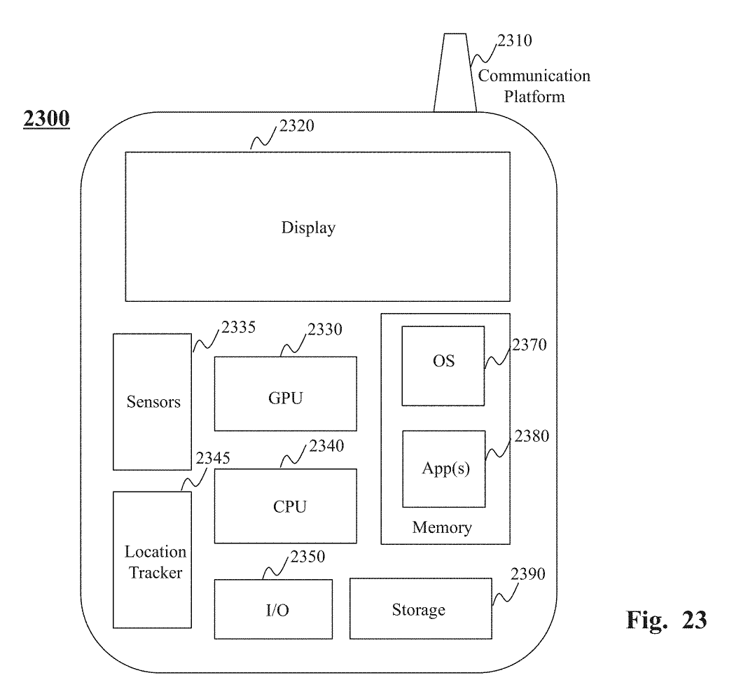

FIG. 23 depicts the architecture of a mobile device which can be used to realize a specialized system implementing the present teaching. This mobile device 2300 includes, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 2300 in this example includes one or more central processing units (CPUs) 2340, one or more graphic processing units (GPUs) 2330, a display 2320, a memory 2360, a communication platform 2310, such as a wireless communication module, storage 2390, and one or more input/output (I/O) devices 2350. Any other suitable component, including but not limited to a system bus or a controller (not shown), may also be included in the mobile device 1700. As shown in FIG. 23, a mobile operating system 2370, e.g., iOS, Android, Windows Phone, etc., and one or more applications 2380 may be loaded into the memory 2360 from the storage 2390 in order to be executed by the CPU 2340.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to the present teachings as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

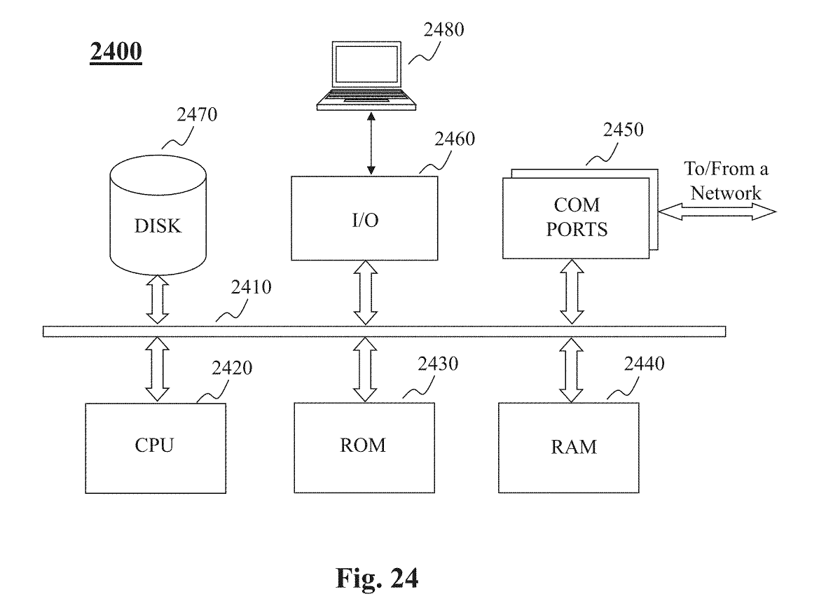

FIG. 24 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 2400 may be used to implement any component of the present teachings, as described herein. Although only one such computer is shown, for convenience, the computer functions relating to the present teachings as described herein may be implemented in a distributed fashion on a number of similar platforms, to distribute the processing load.

The computer 2400, for example, includes COM ports 2450 connected to and from a network connected thereto to facilitate data communications. The computer 2400 also includes a central processing unit (CPU) 2420, in the form of one or more processors, for executing program instructions. The exemplary computer platform includes an internal communication bus 2410, program storage and data storage of different forms, e.g., disk 2470, read only memory (ROM) 2430, or random access memory (RAM) 2440, for various data files to be processed and/or communicated by the computer, as well as possibly program instructions to be executed by the CPU. The computer 2400 also includes an I/O component 2460, supporting input/output flows between the computer and other components therein such as user interface element. The computer 2400 may also receive programming and data via network communications.

Hence, aspects of the methods of the present teachings, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other enhanced ad server into the hardware platform(s) of a computing environment or other system implementing a computing environment or similar functionalities in connection with the present teachings. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the present teachings as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A battery pack, comprising:
a plurality of battery modules, each of which includes more than one battery cells and an associated module service management controller; and
a pack service management controller coupled with the plurality of battery modules and configured for initiating, if it determines that a battery service is needed based on information received from the plurality of battery modules, a service request to a battery service provider with information related to the battery pack and/or to the plurality of battery modules.

2. The battery pack of claim 1, wherein each of the plurality of battery modules is individually replaceable and associated with a battery module identifier (BMID) that uniquely identifies the battery module.

3. The battery pack of claim 1, further comprising a battery pack configuration that specifies information related to the battery pack and connections among the plurality of battery modules in the battery pack.

4. The battery pack of claim 3, wherein the information related to the battery pack includes at least one of a plurality of BMIDs associated with the plurality of battery modules, parameters for each of the plurality of battery modules, and a specification of a layout of the plurality of battery modules.

5. The battery pack of claim 4, wherein the parameters for each of the plurality of battery modules includes at least one of dimension, capacity, density, and pose of the battery module.

6. The battery pack of claim 1, wherein the module service management controller associated with a battery module comprises
a module status monitor configured for monitoring the status of the battery module; and
a self-initiating module service requester configured for initiating a module service request based on the monitored status of the battery module.

7. The battery pack of claim 6, wherein the self-initiating module service requester comprises:
a module service determiner configured for determining, based on a service condition configuration, whether the monitored status of the battery module warrants a battery service; and
a service request generator configured for sending a module service request with information related to the battery module, when it is determined that the battery service is warranted.

8. The battery pack of claim 7, wherein the information related to the battery module includes one or more characteristic parameters read from the battery module.

9. The battery pack of claim 6, wherein the self-initiating module service requester further comprises a module location determiner configured for determining a pose of the battery module in the battery pack, wherein the pose is to be used when the battery module is replaced by a robot.

10. The battery pack of claim 1, wherein the pack service management controller comprises:
a service schedule determiner configured for determining, based on at least one module service request received from the plurality of battery modules, whether a battery service is needed;
a service initiator configured for sending, when the battery service is needed, a service request to the battery service provider;
a service communication analyzer configured for analyzing a response from the battery service provider in response to the service request.

11. The battery pack of claim 10, wherein the battery service provider is one of a plurality of distributed service centers and a battery service central control center.

12. The battery pack of claim 10, further comprising a geo positioning unit configured for obtaining a geo position of the battery pack.

13. The battery pack of claim 12, wherein the pack service management controller further comprises a service center selector configured for selecting, when the battery service is needed, at least one service center suitable for the needed battery service based on the geo position of the battery pack.

14. The battery pack of claim 10, wherein the pack service management controller further comprises a battery/application coordinator configured for coordinating, based on the response received from the battery service provider, with an application in which the battery pack resides to obtain the requested battery service.

15. A battery module, comprising:
a plurality of battery cells;
a peripheral circuit coupled with the plurality of battery cells; and
a module service management controller coupled with the plurality of battery cells and the peripheral circuit and configured for initiating a module service request when a battery service is needed, wherein
the battery module is associated with a battery module identifier (BMID) that uniquely identifies the battery module.

16. The battery module of claim 15, wherein the module service management controller comprises:
a module status monitor configured for monitoring the status of the battery module; and
a self-initiating module service requester configured for initiating the module service request based on the monitored status of the battery module.

17. The battery module of claim 16, wherein the self-initiating module service requester comprises:
a module service determiner configured for determining, based on a service condition configuration, whether the monitored status of the battery module warrants a battery service; and
a service request generator configured for sending a module service request with information related to the battery module, when it is determined that the battery service is warranted.

18. A system for providing battery service, comprising:
a service request processor configured for processing a service request for a battery service originated by a battery having a first unique identifier;
a service scheduler configured for scheduling the requested battery service based on information related to the battery including a current state of the battery;
a service configuration unit for automatically configuring resources needed for the requested battery service, including a replacement battery to be used to replace the battery, wherein the replacement battery is associated with a second unique identifier and has a deployment state;
a service delivery center configured for performing the requested battery service using the configured resources; and
a post service handling unit configured for determining a service charge based on the current state of the battery and the deployment state of the replacement battery.

19. The system of claim 18, wherein the service delivery center comprises
a plurality of stations, wherein at least one of the plurality of stations connects to a first channel along which a replacement battery is to be transferred to the station and a second channel along which a replaced battery is to be transferred out of the station.

20. The system of claim 18, further comprising
a battery re-condition center configured for re-conditioning a replaced battery transferred out of a station after the battery service is performed;
a battery re-deployment initializer configured for initializing a re-conditioned battery in the battery re-condition center and transferring the initialized re-conditioned battery to a battery deployment center configured for re-deploying a re-conditioned battery.

21. The system of claim 20, wherein the service configuration unit comprises
the battery deployment center configured for identifying a replacement battery suitable for the requested battery service;
a channel switch configured for switching a station to be connected with the first and second channels; and
a service robot configuration center for configuring a robot for performing the requested battery service based on the information related to the battery.
